(19) United States
(12) Patent Application Publication
(10) Pub. No.: US 2026/0083152 A1
(43) Pub. Date: Mar. 26, 2026

(54) ICE CREAM PRODUCTS WITH REDUCED SUGAR CONTENT AND ENHANCED RESISTANCE TO THERMAL CYCLES AND ICINESS

(71) Applicant: OMEGA 3 GALILEE LTD, Teradion (IL)

(72) Inventors: Alisa DUNKEL, Karmiel (IL); Noy BELACHSAN ADLER, Kibutz Yagur (IL); Shani BEN ZVI, Shechania (IL)

(73) Assignee: OMEGA 3 GALILEE LTD, Teradion (IL)

(21) Appl. No.: 19/408,399

(22) Filed: Dec. 4, 2025

Related U.S. Application Data
(63) Continuation of application No. PCT/IL2024/050551, filed on Jun. 5, 2024.
(60) Provisional application No. 63/471,006, filed on Jun. 5, 2023.

(51) Int. Cl. A23G 9/40; A23G 9/24; A23G 9/42; A23G 9/48

(52) U.S. Cl. CPC A23G 9/40; A23G 9/245; A23G 9/42; A23G 9/48; A23G 2200/06; A23G 2200/08; A23G 2200/12; A23G 2200/14; A23G 2220/20

(57) ABSTRACT

Ice cream products and preparation methods are provided for reducing sugar content while maintaining the sweetness of the ice cream, and/or for enhancing ice cream resistance resistant against iciness and texture damage due to temperature fluctuations. Ice cream products comprise a mixture of between 4-15 wt % dietary fibers, mixed with milk powder, 25-70 wt % milk and 0-29 wt % cream, between 1-40 wt % of a microcrystalline sugar-in-oil suspension (e.g., having D50<15 μm), added to the mixture after cooling and optionally aging, and gently homogenized therewith. The micronized sugar (remaining in part within the fat globules) enhances the sweetness, and together with the addition of the dietary fibers to the initial mixture-synergistically enhance the ice cream's resistance to iciness and texture damage due to temperature fluctuations.

### CROSS REFERENCE TO RELATED APPLICATIONS

This application is a Continuation of PCT International Application No. PCT/IL2024/050551, International Filing Date Jun. 5, 2024, which claims the benefit of U.S. Provisional Patent Application No. 63/471,006, filed Jun. 5, 2023, which is hereby incorporated by reference in its entirety.

### BACKGROUND OF THE INVENTION

### 1. Technical Field

The present invention relates to the field of ice cream production, and more particularly, to ice cream products with reduced sugar and/or enhanced resistance to freeze-thaw cycles.

### 2. Discussion of Related Art

Solutes in ice cream, such as sugar, decrease the freezing point of water (e.g., according to Raoult's law). The freezing rates and thawing cycles control ice crystal growth with respect to the depressed freezing point and local solute concentration as well as with respect to emulsification characteristics of oily components of the ice cream. For example, fast freezing rates promote the formation of many small ice crystals, while slow freezing rates and/or thawing cycles allow larger ice crystals to grow in the ice cream. It is noted that the freezing process is complex, as it depends on the extent of frozen ice crystals and on the changing concentration of solutes that are removed from the aqueous solution during the freezing process, as well as on the temperature distribution within the freezing mass and the released latent heat during the freezing process. Moreover, the freezing temperature drops as the solutes are concentrated in the remaining aqueous phase, and the viscosity of the remaining aqueous phase increases, decreasing the diffusion properties of the system and hindering crystallization.

Thawing and re-crystallization due to heat shock and temperature fluctuations repeat this process under less controlled or uncontrolled conditions, changing the distribution of ice crystals and their size distribution. For example, small ice crystals are more susceptible to melting and the added water increases the amount of unfrozen water. However, once temperature decreases, this water does not form the original small water crystals but is deposited on the surface of larger crystals-modifying the ice crystal size distribution and therefore modifying the ice cream texture, generally making is coarser and icier. For example, accidental heating of commercial ice cream from −20° C. to above −10° C. or above −5° C. typically results in formation of ice crystals within the ice cream when the ice-cream is re-cooled, for example below −15° C., which detract from the ice cream's smooth texture. At the extreme, undergoing full or partial thaw-freeze significantly deteriorate the texture and quality of commercial ice creams.

Typical fast freezing techniques involve using a well-maintained barrel freezer, in which the ice cream is hardened rapidly, and temperature fluctuations during storage and distribution are avoided as much as possible. Additionally, ice cream stabilizers are added to emulsifiers in the ice cream blends to reduce ice and lactose and/or sucrose crystal growth during storage and to maintain texture smoothness. Typically, stabilizers reduce water mobility due to the entangled network structures formed, and thus impede water crystal growth. Examples for ice cream stabilizers include locust bean gum, guar gum, carboxymethyl cellulose, sodium alginate, carrageenan, sucrose ester and xanthan. Additional factors include total solids content and sugar and lactose concentrations, which further modify ice cream stability with respect to the processes and parameters described above.

Development of a coarse, icy texture is the most frequently occurring textural defect in ice cream, limiting its shelf life and reducing its quality. Iciness depends on the conditions of ice cream storage—while in fresh ice cream the ice crystals are numerous, small and uniform—and therefore not detected when eaten—heat shock due to large temperature fluctuations during storage results in uncontrolled growth of the crystals as well as coarse, icy texture—as illustrated in FIGS. 2A and 2B (from the “Ice Cream Technology” e-Book by H. Douglas Goff)—Cryo-scanning electron micrographic images of ice cream before and after temperature fluctuations, respectively. While ice cream is frozen quickly during production, to yield very small water crystals that contribute significantly to the smooth texture of the ice cream product, thawing cycles along the supply chain and at the point of sale frequently cause accretion and growth of ice crystals—damaging the product's texture. For example, FIG. 2A provides a comparison between fresh ice cream and ice cream that has undergone temperature fluctuations (heat shocked ice cream)-illustrating the growth of ice crystals in the latter in cryo-scanning electron micrographs. FIG. 2B illustrates the growth of ice crystals by fusing and accretion during thawing cycles. It is noted that ice cream is a complex composite material that combines a water phase, a hydrophobic phase (fat and oil), sugar, air and additional components-all forming an intricate three-dimensional matrix resulting from interactions between these ingredients. Thawing cycles (heat shock), which result from uncontrolled conditions along the supply chain and at the point of sale, are understood to change these interactions-affecting the texture of the ice cream from its manufacture to the end user.

Cook and Hartel 2010 (“Mechanisms of ice crystallization in ice cream production.” Comprehensive reviews in food science and food safety 9.2:213-222) describe ice cream as a partially frozen mixture of milk, cream, sugar, stabilizers, and emulsifiers. Ice cream is equally an emulsion, a dispersion, and a foam. The dispersion and emulsion consist primarily of a freeze-concentrated aqueous serum phase containing sugar and the dry matter contents surrounding dispersed ice crystals and fat globules.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides an ice cream product that is resistant against iciness and texture damage due to temperature fluctuations, the ice cream product comprising, by weight: a mixture of between 4-15 wt % dietary fibers, mixed with milk powder, 25-70 wt % milk and 0-29 wt % cream, between 1-40 wt %, or between 10-40 wt % of a sugar-in-oil suspension, comprising microcrystalline sugar particles suspended in oil (e.g., with between 10-40 wt % of sugar from the oil in the suspension), wherein a diameter of the microcrystalline sugar particles is reduced by grinding in the suspension to have a median diameter of less than 15 μm, wherein the sugar-in-oil suspension is added to the mixture after cooling and optionally aging, and is homogenized therewith, wherein a total fat content of the ice cream product is at least 15 wt %, and wherein the ice cream product optionally further comprises up to 2 wt % of additives in total, the additives comprising flavors and/or stabilizers.

One aspect of the present invention provides a method of preparing an ice cream product that is resistant against iciness and texture damage due to temperature fluctuations, the method comprising: mixing milk powder, fillers and optionally stabilizer in powder form, with heated milk and cream in liquid form, without including sugar in the powder mixture or oil in the liquid mixture, pasteurizing and then cooling and optionally aging the mixture, adding to the aged mixture and gently homogenizing therewithin-a sugar-in-oil suspension, comprising microcrystalline sugar particles suspended in oil, wherein a diameter of the microcrystalline sugar particles is reduced by grinding in the suspension to have a median diameter of less than 15 μm, and freezing and packaging the ice cream product.

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee

For a better understanding of embodiments of the invention and to show how the same may be carried into effect, reference will now be made, purely by way of example, to the accompanying drawings in which like numerals designate corresponding elements or sections throughout.

FIG. 1A is a high-level schematic illustration of the disclosed ice cream preparation process, according to some embodiments of the invention.

FIG. 1C is a high-level schematic illustration of disclosed ice cream preparation processes, according to some embodiments of the invention, compared with FIG. 1B that illustrates current ice cream preparation practice.

FIG. 1D is a high-level schematic illustration of methods of preparing ice cream products, according to some embodiments of the invention.

FIG. 2A provides a comparison between fresh ice cream and ice cream that has undergone temperature fluctuation (heat shocked ice cream)-illustrating the growth of ice crystals in the latter in cryo-scanning electron micrographs, according to prior at.

FIG. 2B illustrates the growth of ice crystals by fusing and accretion during thawing cycles, according to prior art.

FIGS. 3A-3D provide experimental data concerning the relation of sweetness and resistance to iciness to fat concentration, according to some embodiments of the invention.

FIGS. 4A-4E provide experimental data concerning the relation of sweetness and resistance to iciness to fat type, according to some embodiments of the invention.

FIG. 5 provides experimental data concerning the relation of the resistance to iciness to the type of filler fibers, according to some embodiments of the invention.

FIGS. 6A-6C and 7A-7C provide experimental data concerning the relation of sweetness and resistance to iciness to sugar concentration, particle size and state of crystallinity, according to some embodiments of the invention.

FIG. 8 provides experimental data concerning the relation of the resistance to iciness to the type of stabilizer, according to some embodiments of the invention.

FIGS. 9A-9D provide experimental data concerning the relation of sweetness to parameters of the mixing process of the suspension of micronized sugar in oil into the initial ice cream mixture, according to some embodiments of the invention.

FIGS. 10A and 10B provide experimental results comparing to prior art brands the iciness resistance of disclosed ice cream products according to some embodiments of the invention.

FIGS. 11A-11C provide experimental results from five tasting panels, comparing disclosed ice creams with prior art ice creams and with ice creams prepared with some modification of the ingredients, according to some embodiments of the invention.

FIGS. 12A-12C provide experimental results from a tasting panel of five people, comparing the effects of different amounts of dietary fibers on the resistance to iciness and on the stickiness of the ice product, according to some embodiments of the invention.

FIGS. 13A-13D provide microscope images comparing the grain structure after three freeze-thaw cycles of disclosed ice cream products compared to prior art products, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Some embodiments of the present invention provide efficient and economical methods and mechanisms for preparing low sugar ice cream and thereby provide changes and improvements to various ice cream products and to the technological field of ice cream production. In particular, disclosed compositions provide ice cream that is more resistant to iciness upon heating-cooling cycles, more resistant to freeze-thaw cycles and exhibits no or reduced resulting iciness as a result of warming and/or freeze-thaw cycles.

Ice cream products and preparation methods are provided for reducing sugar content while maintaining the sweetness of the ice cream, and/or for enhancing ice cream resistance to freeze-thaw cycles. Ice cream products comprise a mixture of between 4-15 wt % dietary fibers, mixed with milk powder, 25-70 wt % milk and 0-29 wt % cream, between 1-40 wt %, or between 10-40 wt % of a microcrystalline sugar-in-oil suspension (e.g., having D90<30 μm, D90<15 μm, D90<10 μm and/or D50<15 μm, D50<10 μm, D50<5 μm, or any intermediate values, and, e.g., with between 10-40 wt % of sugar from the oil in the suspension), added to the mixture after cooling and optionally aging, and gently homogenized therewith. The micronized sugar (remaining in part within the fat globules) enhances the sweetness, and together with the addition of the dietary fibers to the initial mixture-to synergistically enhance the ice cream's resistance to heat shock, to prevent iciness and to maintain the ice cream texture under freeze-thaw cycles.

In various embodiments, the microcrystalline sugar-in-oil suspension may comprise between 10-65 wt % microcrystalline sugar particles (e.g., 10 wt %, 15 wt %, 20 wt %, 25 wt %, 30 wt %, 35 wt %, 40 wt %, 45 wt %, 50 wt %, 55 wt %, 60 wt %, 65 wt %, or intermediate values). In some embodiments, the sugar concentration may be further reduced, and/or possibly sweetener may be added.

In various embodiments, the microcrystalline sugar-in-oil suspension may be included in the ice cream product at between 1-40 wt % (e.g., 1 wt %, 5 wt %, 10 wt %, 15 wt %, 20 wt %, 25 wt %, 30 wt %, 35 wt %, 40 wt %, or intermediate values), depending on further compositional or other requirements (e.g., total fat and sugar content, specified sweetness, etc.).

Ice cream products and preparation methods are provided for reducing sugar content while maintaining the sweetness of the ice cream, and/or for enhancing ice cream resistance against iciness and texture damage due to temperature fluctuations. Ice cream products comprise, by weight: between 10-40% of a sugar-in-oil suspension, comprising crystalline sugar particles having a median diameter of less than 15 μm, suspended in oil (e.g., MCT-medium-chain triglycerides, or coconut oils), between 4-15% dietary fibers, as well as milk, cream, milk powder, additives and optionally flavors. Preparation methods include using the sugar-in-oil suspension to provide low-sugar sweetness (e.g., having the same sweetness with a reduced sugar content), and including between 4-15% dietary fibers, as well as milk (e.g., between 25-35% by weight 3% fat milk), cream (e.g., between 0-35% by weight), milk powder (e.g., between 0.1-6% by weight) additives (e.g., less than 1% w/w) and optionally flavors. In certain embodiments, the median diameter of the suspended crystalline sugar particles was even smaller, reaching less than 10 μm and even down to 5 μm or 3 μm median diameter (D50). Preparation methods include using the sugar-in-oil suspension to provide low-sugar sweetness and including between 4-15% dietary fibers (e.g., primarily as a filler for the reduced amount of sugar, and secondarily to synergistically enhance the ice cream's resistance to heat shock and temperature fluctuations, and to maintain its texture under temperature fluctuations). Disclosed ice cream products have a low sugar content, a high level of sweetness (despite the low level of sugar, due to the increased surface area of the suspended micronized sugar crystals) and a natural taste, lacking an after-taste, and moreover may be resistant against iciness due to temperature fluctuations (e.g., warming and cooling the ice cream above and then below any of −10° C., −5° C., 0° C. or intermediate values, as well as possibly freeze-thaw cycles as described herein). Disclosed ice cream products may further be coated by a coating having a high thawing temperature, such as cocoa butter, sweet butter made with suspended micronized sugar particles (e.g., similar to suspension 110, with

MCT, coconut, cocoa or other type of oil, possibly mixed with cocoa mass and/or chocolate) or coatings comprising cocoa butter and/or sweet butter made with suspended micronized sugar particles.

U.S. Patent Application Publications Nos. 2022/0117250 and 2022/0125066, as well as Israeli U.S. Pat. Nos. 268,457 and 289,782, incorporated herein by reference in their entirety, disclose, among others, (i) various suspensions of micronized sugar in oil, prepared by suspending crystalline sugar in oil and grinding the crystals to a much smaller size in the suspension-enabling production of very small sugar crystals that provide a strong sweet taste for a much smaller amount of sugar-due to the increased surface area of the micronized crystals-which is not possible in the prior art due to agglomeration and risk of explosion; and (ii) various types of MCT oil, including at least one heterogenous triglyceride comprising three non-identical aliphatic saturated fatty acids that include at least one fatty acid with more than ten, or more than twelve carbon atoms (e.g., three aliphatic saturated fatty acids with 6-22 carbon atoms, at least one of which with ten carbon atoms, twelve or more), which may be mostly or fully saturated (e.g., 90%, 95%, 99% or 100% saturated fatty acids), and may include a small amount of antioxidants (e.g., 200 mg/l or less) to significantly increase its shelf life. The reduction of sugar particle size may be carried out in one, two or more stages, e.g., using high shear mechanical mixing and high-pressure high-shear microfluidizing and/or ball milling on consecutive step, to reach a median particle size of between 0.1 and 15 μm. The micronized sugar content in the MCT oil may be any of 5%, 10%, 15%, 20%, 25%, 30%, 35%, 40%, 45%, 50%, 55%, 60%, 65%, 70%, 75% w/w, or intermediate values. As shown herein, ice cream products may be prepared with any type of MCT oil, or with other types of disclosed saturated or unsaturated oils, and crystalline sugar particles having reduced sizes, achieved by milling of oil-sugar suspensions, e.g., as disclosed in U.S. Patent Application Publications Nos. 2022/0117250 and 2022/0125066, as well as Israeli U.S. Pat. Nos. 268,457 and 289,782, incorporated herein by reference in their entirety.

In addition to the nutritional and regulatory benefits of using saturated oils and reduced sugar content (with similar sweetness and other organoleptic parameters), the inventors have found out that disclosed ice cream products also have improved durability and resistance with respect to ice crystal growth resulting from warming and/or thawing cycles. For example, disclosed ice cream products may be resistant against iciness after heating above −10° C. or above −5° C., or in more extreme cases, disclosed ice cream products may be resistant against iciness after at least one, two, three or more freeze-thaw cycles, as disclosed herein. Disclosed methods include ways of preparing the ice cream products, which ensure resistance of the ice cream products against iciness after heating above −10° C. or above −5° C., and re-cooling to a lower temperature for one or several cycles; or in more extreme cases, after at least one, two, three or more freeze-thaw cycles.

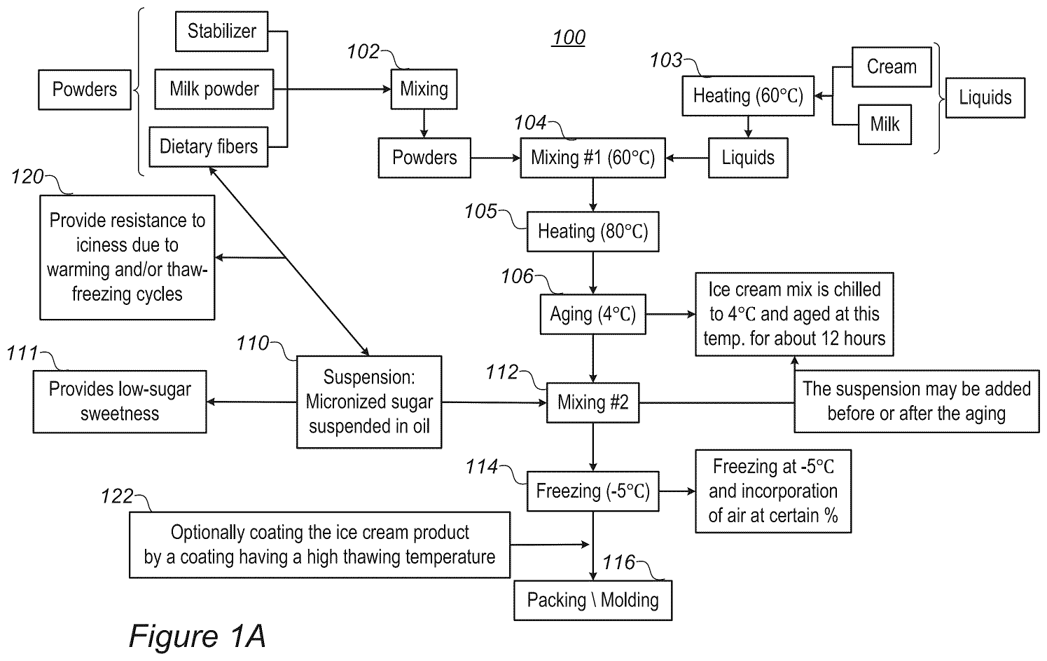

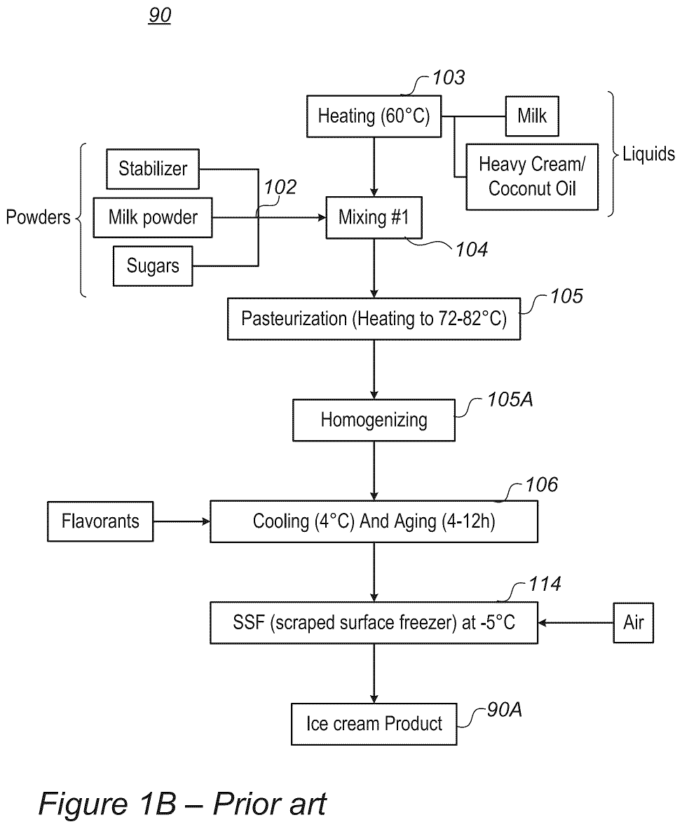

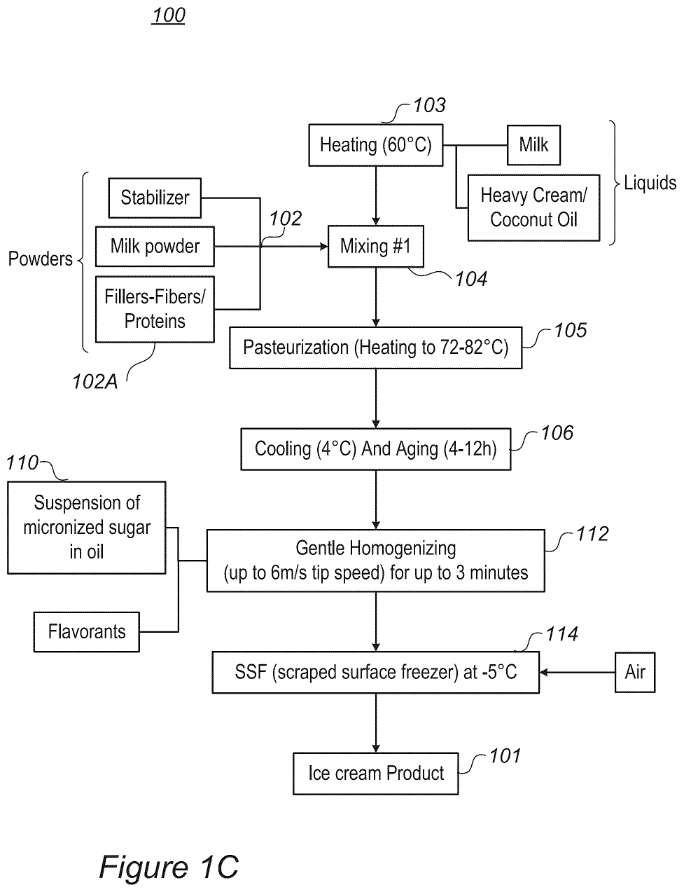

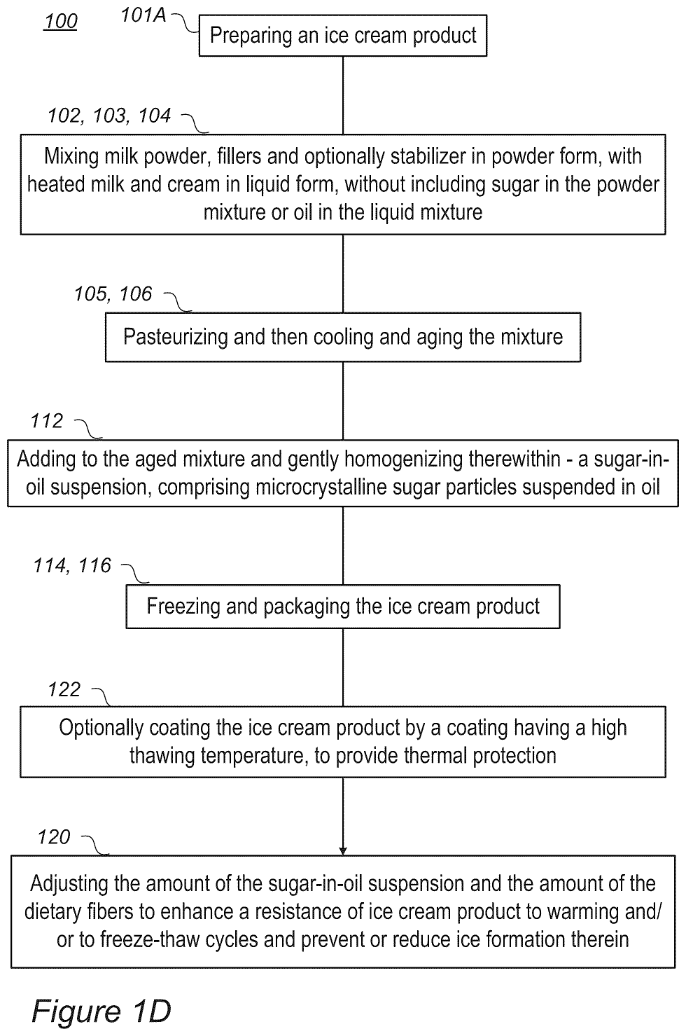

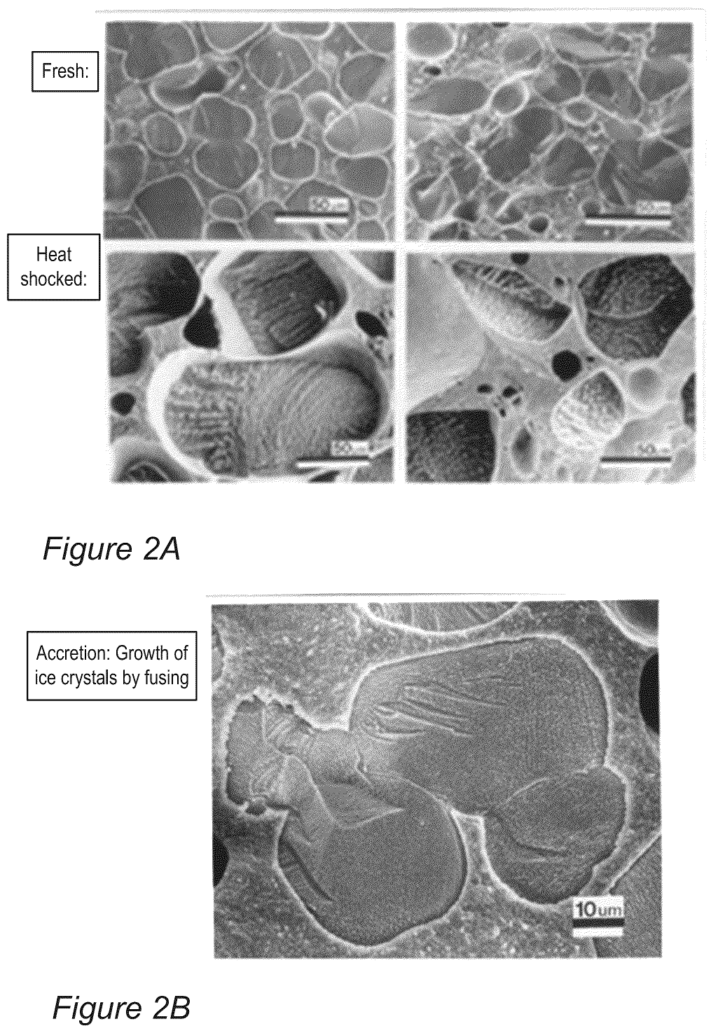

FIG. 1A is a high-level schematic illustration of the disclosed ice cream preparation process 100, according to some embodiments of the invention. Following the mixing of powder ingredients (e.g., fibers, milk powder, stabilizer(s), stage 102), the liquid milk and cream are heated to 60° C. (stage 103) and added to the powder ingredients (stage 104). The mixture is further heated to 80° C. (or up to 100° C., stage 105) and then cooled to 4° C. and aged at this temperature for 12 hours (stage 106). Before or after the aging, the sugar-in-oil suspension 110 (comprising crystalline sugar particles having a median diameter of less than 15 μm, suspended in MCT oil, prepared by one or more grinding steps of crystalline sugar in oil, as disclosed in U.S. Patent Application Publications Nos. 2022/0117250 and 2022/0125066, stage 90) is added to the mixture (stage 112) and frozen to −5° C. under inclusion of air at a given percentage (stage 114), followed by packing and/or molding the ice cream product into a desired shape and package (stage 116). It is noted that sugar-in-oil suspension 110 may be added to the cooled mixture before or after the aging, to maintain the suspension of the micronized sugar particles in the oil phase and prevent their dissolution in the water phase-maintaining the large surface are of the micronized particles. While some dissolution may occur during the mixing, or due to freeze-thaw cycles, most of the sugar is kept as oil-suspended micronized particles to yield the low sugar-high sweetness effect. When micronized sugar-in-oil suspension 110 is added to the mixture before the aging, it may be added after cooling the mass to about 4-7° C.

Disclosed methods 100 of preparing an ice cream product thus comprise using a sugar-in-oil suspension 110 (stage 112), which comprises crystalline sugar particles having a median diameter of less than 15 μm, less than 10 μm or less than 5 μm-suspended in MCT (medium-chain triglycerides) oil-to provide low-sugar sweetness (stage 111), and including between 4-15% dietary fibers, wherein the amount of the sugar-in-oil suspension and the amount of the dietary fibers are adjusted (and optimized) to enhance a resistance of ice cream product to temperature fluctuations such as warming (e.g., to above −10° C. or above −5° C., intermediate or higher values, and re-cooling to a lower temperature for one or several cycles) and/or to freeze-thaw cycles and prevent or reduce ice crystals formation therein (stage 120). Further stages 102 to 116 of method 100 described herein, disclose the processing of the micronized-sugar-in-oil suspension, with additional ingredients such as milk, cream, milk powder, less than 1% each of additives, and optionally flavors, in the ice cream production process to yield the ice cream product. Specifically, method 100 may further comprise mixing powders including the dietary fibers, the milk powder and the stabilizer (stage 102), mixing and heating liquids including the milk and the cream (stage 103), mixing the powders and the liquids (stage 104), further heating the mixture (stage 105) and cooling and aging the mixture (stage 106), adding and mixing the sugar-in-oil suspension into the aged mixture (stage 112), and freezing (stage 114) and packing and/or molding the mixture of the sugar-in-oil suspension in the aged mixture to yield the ice cream product (stage 116). It is noted that adding suspension 110 after mixing the other ingredients (and optionally after aging the mixture) may enable retention of the small particle size of the micronized sugar in the end product—contributing to achieve enhanced sweetness with low sugar content. Method 200 may further comprise coating the ice cream product by a coating having a high melting temperature (stage 122), such as cocoa butter and/or sweet butter made with suspended micronized sugar particles. For example, coatings with melting temperatures of, e.g., 10° C. or higher—may withstand partial thawing and maintain, or help maintain the texture of the coated ice cream product, preventing or at least reducing ice crystal growth upon re-freezing.

FIG. 1C is a high-level schematic illustration of disclosed ice cream preparation process 100, according to some embodiments of the invention, compared with FIG. 1B that illustrates current ice cream preparation practice. It is noted that various modifications in disclosed ice cream preparation process 100 compared to current practice 90 change the way oil, especially sugar and optionally fibers are incorporated into the ice cream products-resulting in improved products that are, e.g., more resistant to temperature fluctuation, have enhance sweetness achieved using a smaller amount of sugar and/or have an improved texture. Changes implemented in disclosed ice cream preparation process 100 enable incorporating various preparation stages that yield improved products, and at least in this sense, improved production processes 100 are provided.

While in current practice 90 (FIG. 1B) powders including milk powder, stabilizers and sugar are mixed (stage 102), and then mixed (stage 104) with heated (stage 103) liquids including milk and cream and/or oils, the inventors have found out that improved or modified process 100 avoids including oils in the liquids and sugar in the powders. Instead, recited sugar-in-oil suspension 110 is added to the mixture after it is pasteurized (stage 105) and cooled and aged (stage 106). Following the addition of sugar-in-oil suspension 110, the mixture is gently homogenized (stage 112) (e.g., mixed with a mixer tip speed of p to 6 m/s for up to 3 minutes) before freezing (stage 114) to yield ice cream product 101. As disclosed herein, fibers or fillers may be added to the powder mixture (stage 102) if required, e.g., to replace the volume of reduced sugar content or to further improve the resistance to temperature fluctuations such as warming to above-10° C. or above −5° C. or to intermediate or higher temperatures, and re-cooling to a lower temperature for one or several cycles and/or to thaw-freeze cycles or heating-cooling cycles (an effect found surprisingly to exist only in disclosed processes 100 and not in prior art practices 90).

For example, in current commercial ice cream production practice 90 (FIG. 1B), the liquid ingredients, such as milk and coconut oil or MCT oil, are combined in a tank and heated to about 60° C. (stage 103). Then, powdered ingredients are added (stage 104) to the mixture while stirring. The mixture is then pasteurized (stage 105) and homogenized (stage 105A) to create a stable emulsion by breaking down the fat globules. After that, the mixture is cooled and aged (stage 106) for at least 4 hours at a temperature of about 4° C. Flavoring is added before the mix is pumped into the scraped-surface freezer (SSF) (stage 114), where about 50% of the water is frozen and air is incorporated into the product. The product 90A, at approximately −5 to −6° C., is then filled into its retail container as it exits the SSF.

In contrast, disclosed processes 100 (FIG. 1C) are modified and include changes in the ice cream formulation and changes in the process steps compared to regular high-sugar ice cream. As the finely ground sugar in sugar-in-oil suspension 110 enables reduction in the amount of sugar to achieve the same degree of sweetness (see herein), some of the sugar may be replaced by some bulking fillers (denoted 102A) like fibers or protein which are mixed, pasteurized, cooled, and aged for 12 h at 4° C. (stage 102, 104, 105, 106). After aging step (stage 106), sugar-in-oil suspension 110 is added to the mixture and homogenized (stage 112) in a gentle low shear mixing process. Then the complete ice cream mix is transferred through the ice cream machine or SSF (stage 114) to form disclosed products 101. Without being bound by theory, it seems that the alteration in the process stems from ice cream's nature as an emulsion, in which the water phase can dissolve the micronic sugar found in sugar-in-oil suspension 110, nullifying its sweetening enhancement effect. Accordingly, the later addition of sugar-in-oil suspension 110 maintains at least part of the microcrystalline sugar in the oil phase, and thus maintains enhanced sweetness.

Certain embodiments comprise ice cream products 101 which have a low level of sugar but still provide a level of sweetness that is comparable to prior art ice creams with higher sugar content. For example, while current ice creams typically contain between 29-17% w/w sugar, disclosed ice cream products may comprise less than 15% sugar by weight (e.g., with 30% w/w suspension 110 comprising 30% w/w sugar, yielding 9% w/w sugar), while maintain its sweetness (and other organoleptic characteristics) compared to current ice cream products. In various embodiments, disclosed ice cream products may comprise between 1-15% sugar by weight, or between 5-12% sugar by weight, or intermediate values-depending on the amount of sugar in suspension 110 (and the degree of particle size reduction which provides the enhanced sweetness) and the amount of suspension 110 used to prepare disclosed ice cream products.

FIG. 1D is a high-level schematic illustration of method 100 of preparing ice cream product 101 (stage 101A), according to some embodiments of the invention. Method 100 may comprise mixing milk powder, fillers and optionally stabilizer in powder form, with heated milk and cream in liquid form, without including sugar in the powder mixture or oil in the liquid mixture (stages 102, 103, 104), pasteurizing and then cooling and aging the mixture (stages 105, 106), adding to the aged mixture and gently homogenizing therewithin-a sugar-in-oil suspension, comprising microcrystalline sugar particles suspended in oil (stage 112), wherein a diameter of the microcrystalline sugar particles is reduced by grinding in the suspension to have a median diameter of less than 15 μm, and finally freezing and packaging the ice cream product (stages 114, 116). In various embodiments, the micronized, microcrystalline sugar particles suspended in the oil after being ground in the suspension may have a size distribution characterized, e.g., by the percentiles D90<30 μm, D90<15 μm, D90<10 μm and/or D50<15 μm, D50<10 μm, D50<5 μm, or any intermediate values.

In various embodiments, with respect to the ice cream product: the fillers may comprise 4-15 wt % dietary fibers, the liquid mixture may comprise 25-70 wt % milk and 0-29 wt % cream, the sugar-in-oil suspension may be added at 1-40 wt % or 10-40 wt %, the total fat content of the ice cream product may be at least 15 wt %, and/or the ice cream product may optionally comprise up to 2 wt % of additives in total, the additives comprising flavors and/or stabilizers. In various embodiments, the oil may comprise at least one of: MCT (medium-chain triglycerides) oil, C10 (capric acid) oil, grape seed oil, refined coconut oil and/or canola oil, or optionally any other oil or fat.

In some embodiments, method 100 may be further configured to have the ice cream product include between 15-36 wt % total fat, to have the ice cream product include between 20-30 wt % of the sugar-in-oil suspension, and/or to have the ice cream product include between 1-20 wt % or between 5-12 wt % sugar.

In some embodiments, method 100 may further comprise coating the ice cream product by a coating having a high thawing temperature, to provide thermal protection (stage 122). The coating may comprise cocoa butter and/or sweet butter made with suspended micronized sugar particles-to provide additional thermal protection, in addition to taste, appearance and other characteristics of ice cream product 101.

In various embodiments, method 100 further comprises adjusting the amount of the sugar-in-oil suspension and the amount of the dietary fibers to enhance a resistance of ice cream product to warming to above −10° C. or above −5° C. or to intermediate or higher temperatures and re-cooling to a lower temperature for one or several cycles, and/or to freeze-thaw (or heating-cooling) cycles and prevent or reduce ice formation therein (stage 120).

Table 1 provides an overview of the composition of disclosed ice cream products and ranges for the individual ingredients, as well as a comparison to prior art ice creams and the main differences in performance and prices, as disclosed herein.

TABLE 1
Ingredients of disclosed ice creams and comparison to the prior art.

| | Percentage in | Acceptable | |
|---|---|---|---|
| Raw material | the recipe | range (w/w) | Prior art |
| Suspension of micronized | 20-30% | between 1-40% | None |
| sugar particles in MCT oil | | | |
| Sugar and oil | Microcrystalline sugar (e.g., D50 < 15 μm) | | Crystaline sugar, |
| | e.g. 10-65% w/w in various types of oil. | | no oil, or sugar |
| | E.g. total 1-20% sugar. | | separate from oil |
| Milk 3% | 40% | between 25-70% | |
| Cream 38% | 2.5%, 29% | between 0-29% | |
| Total fat | 15%, 25%, 36% | between 15-36% | between 7-15% |
| Milk powder | 0.9% | between 0.1-6% | |
| Corn fibers SGF 70R or | 7% | between 4-15%, alternative | |
| other types of fillers | | fiber sources | |
| Fabbri ™ stabilizer | 0.3% | Alternative sources, other | |
| | | thickeners and emulsifiers. | |
| Additives | 0.9% vanilla paste | Optionally flavorings | |

Performance

| | | |
|---|---|---|
| Combined effects on | Increased resistance to iciness (with more fat | No effect of |
| iciness resistance | and with less fat, adjustments of the type of fat) | fibers on iciness |
| Enhanced sweetness | Fibers further enhance resistance | Complete |
| | Enhanced sweetness with less sugar | dissolution of |
| | Remaining sugar microcrystals within fat globules | sugar |

Process

| | | |
|---|---|---|
| Modifications | Addition of fillers or fibers in the initial mix | All ingredients |
| | Addition of the suspension after cooling and | pre-mixed. |
| | aging, followed by gentle homogenizing | Homogenization |
| | | before cooling. |

Non limiting examples for oils used herein include MCT oil (60% C8 and 40% C10 medium chain triglycerides) with a low melting temperature of the saturated fatty acids of ca. 4° C. Coconut oil which was used as the comparative fat to MCT oil contains mostly longer chain fatty acids, and only about 15% of C8 and C10 MCT. It is expected that coconut oil may have a higher iciness resistance than fats with lower MCT content, which are more typical in prior art ice cream products, such as milk butter (1-2% MCT), cocoa butter (0% MCT) and palm oil (0% MCT). Other possible oils include saturated or unsaturated oils which are comparable to MCT oil with respect to their viscosity-temperature characteristics, in particular comparable viscosity at low temperatures, around the freezing point of water (e.g., between −18° C. and 4° C., or between −5° C. and 4° C.). Additional non-limiting examples for oils used herein include C10 (capric acid) oil, grape seed oil, refined coconut oil and/or canola oil, or optionally any other oil or fat.

Non limiting examples for ice cream stabilizers include mixtures of thickeners and emulsifiers such as sodium alginate (E 4010), carrageenan (E 407), locust bean gum (E410), guar gum (E412), sodium carboxymethyl cellulose (E466) (thickeners), and mono and diglycerides of fatty acid (E471) (emulsifiers), e.g., as provided in Neutral Five Cream™ by Fabbri™. In certain embodiments, ice cream stabilizers may comprise sucrose ester (e.g., between 0.05-0.7% w/w), carrageenan (e.g., between 0.005-0.02% w/w) and guar gum (e.g., between 0.01-0.2% w/w). Certain embodiments comprise combinations of materials disclosed above.

Non limiting examples for fibers and protein powders include Corn fibers SGF 70R as used below as well as any of: inulin fibers, maize-based dextrin fibers such as Nutriose® FM10 fibers, soybean flour, rice flour and other fillers a like.

Non-limiting examples for the liquids include 1-4% (e.g., 3%) fat milk and 32-42% (e.g., 38%) fat cream, as well as coconut milk and coconut cream, or other types of plant-based types of milk and cream (based, e.g., on soy, almond, oats, rice, other nuts, etc.), possibly with addition of fat for the creams or in combination with regular milk.

In certain embodiments, disclosed ice cream products may further be coated by a coating having a high thawing temperature, such as coating of cocoa butter and/or sweet butter made with suspended micronized sugar particles. The coating may enhance the resistance of the ice cream products to temperature fluctuations (e.g., warming to above −10° C. or above −5° C. or to intermediate or higher temperatures, and re-cooling to a lower temperature for one or several cycles), and/or to thaw-freeze (or heating-cooling) cycles, delaying internal thawing of the product, or reducing the maximal temperatures to which it is thawed, especially concerning the outer layers of the products. The coatings thus further contribute to maintaining the structure and the texture of disclosed ice cream products and allow re-freezing of the ice cream product, with minimal or no damage to texture (such as iciness).

The inventors have found out experimentally, that a synergistic effect exists with respect to the use of micronized sugar particles suspended in oil, use of MCT oil, C10 (capric acid) oil, grape seed oil, refined coconut oil and/or canola oil and using dietary fibers—leading to reduced iciness of the ice cream product following freeze-thaw cycles. Specifically, as shown below, no single element yielded iciness resistance by itself. Moreover, the contribution of dietary fibers to reduced iciness was found to be prevalent only in ice cream products that were prepared using the micronized sugar-in-oil suspension.

Ice cream is a complex colloidal frozen system that consists of partially coalesced fat droplets, air cells, ice crystals, and a continuous aqueous phase in which the polysaccharides, proteins, lactose, and mineral salts are dispersed. Due to the thermodynamic instability of the ice cream, recrystallization phenomena occur during storage, leading to the gradual increase of the ice crystals' mean size and the deterioration of the product quality characteristics. If the temperature during the frozen storage of ice cream increases, some of the ice crystals, particularly the smaller ones, melt, and consequently, the amount of unfrozen water in the serum phase increases. Conversely, as temperatures decrease, water will refreeze but does not renucleate. Rather, it is deposited on the surface of larger crystals, so the net result is that the total number of crystals diminishes and the mean crystal size increases.

As a common practice, recrystallization is effectively controlled by the addition of hydrocolloids due to their ability to control water diffusion from the serum to the ice crystal interface, which diminishes water mobility.

Ice cream mix with a higher total solids content is expected to exhibit improved resistance to temperature fluctuations that can lead to iciness. Consequently, ice creams with reduced sugar content are typically more vulnerable to ice crystal growth during thawing cycles. However, disclosed ice cream products and production methods were surprisingly found to achieve a substantial 25-50% reduction in sugar compared to commercial ice creams while remarkably maintaining their resistance to temperature fluctuation-induced iciness and their sweetness.

To explain the iciness resistance and sweetness enhancement facilitated by using disclosed processes, utilizing the micronized sugar in oil suspensions in ice cream, a comprehensive assessment is provided on various types and potential ranges of each ingredient within the ice cream formulation. In addition, disclosed ice cream products were tested in comparison to commercial ice creams to prove their advantages to temperature fluctuations. Specifically, the following experimental results pertain to the relative contributions of microcrystalline sugar, of its presence in the oil suspension, of the types of oil and their freezing points, or amounts of fat and fibers as well as of combinations of these factors—and elucidate the advances achieved by the disclosed methods and material combinations.

Ice Cream Composition—For each ingredient in the ice cream formulation, different types, and possible ranges were tested. (1) Fat: type (MCT oil, C10, grape seed oil, canola oil, and refined coconut oil) and range (15%, 25%, 36%). (2) Fillers: type (corn fibers, pea fibers, inulin fibers, pea protein, whey protein) and range (0%, 4.7%, 7.5%, 11.6%, 13.7%). (3) Stabilizers (existing stabilizer in comparison to custard/egg yolk). (4) Sugar (Granulated sugar, dissolved in the water phase, in comparison to micronized sugar in oil suspension, and sugar and oil in different milling methods and different Particle Size Distribution (PSD) value). The compositions of the different ice cream samples and their nutritional values are provided in the following Tables 2A-21, with respect to these categories.

Disclosed Ice Cream Sample Preparation. Disclosed ice cream products, e.g., as vanilla ice cream, were prepared in the lab based with the ingredients, and having nutritional values, as listed in the following Tables 2A-21. All the ice creams were prepared in the same conditions. Disclosed ice cream products were prepared in the lab according to the process described in FIG. 1C and stored in the freezer at −20° C. Comparisons were made to Reference Ice Creams—Commercial Ben & Jerry's Vanilla Ice Creams contain Milk, Cream (31%), sugar, Skim Milk, Egg Yolks Vanilla Extract & vanilla beans (0.3%), guar gum, and carrageenan. Nutritional values are detailed in Table 2A.

TABLE 2A
Nutritional values of prior art references

| | | |
|---|---|---|
| Energy (Kcal) | 230.00 | 76.00 |
| Total fat (g) | 15.00 | 0.50 |
| Saturated fat (g) | 8.50 | 0.50 |
| Trans fat (g) | 0.00 | 0.00 |
| Cholesterol (mg) | 64.00 | 0.00 |
| Sodium (mg | 48.00 | 69.60 |
| Total | 20.00 | 16.30 |
| Carbohydrate (g) | | |
| Sugars (g) | 20.00 | 7.00 |
| Dietary Fiber (g) | 0.00 | 8.00 |
| Sugar alcohol (g) | 0.00 | 7.00 |
| Proteins (g) | 3.80 | 4.80 |

Temperature Fluctuation Cycles were used to test resistance to developing iciness. For each tasting panel, the tested part of the ice cream samples underwent controlled temperature fluctuation of three cycles. For each cycle, the ice cream was melted to 3° C. and frozen again to −20° C.

Evaluation Methods—The evaluation of each sample was carried out using both qualitative and analytical assessment methods: (1) Qualitative assessment methods-Taste panels, and (2) Analytical evaluation method-Microscope examination-described in detail below.
(1) Qualitative assessment methods-Taste panels. Tasting Panels were used in sensory analysis to evaluate products according to the way they were perceived by the senses of sight, smell, taste, touch, and hearing. The main assignment of the tasters was to assess the sensorial characteristics of products. A highly skilled panel of tasters was selected and thoroughly trained to ensure professionalism and accuracy in their evaluations. Before tasting the samples were blinded by marking with a 3-digit code and a questionnaire was prepared for each taster. During the panel, each member rated the samples anonymously. After the panel the average score was calculated, and a t-test was conducted to determine the statistical significance. Tasters evaluated and rated the ice cream samples based on various sensorial parameters: (a) Texture—iciness level—the overall amount of ice crystals in the ice cream. The tasters tasted the ice cream samples after 3 cycles of thawing and freezing compared to commercial reference after 3 cycles of thawing and freezing. Scoring method-1=creamy texture, no ice crystals, 10=very icy texture. (b) Taste-Sweetness level or intensity of the sweet taste. The tasters tasted a fresh ice cream sample without thawing and freezing cycles. Scoring method-1=not sweet, 10=very sweet.
(2) Analytical evaluation method-Microscope examination. Microscopes were used for detailed examination and analysis of structures and materials at the microscopic level. In this research, a Zeiss microscope has been used for analyzing ice cream samples. This microscope allows for magnification ranging from ×5 to ×100 and was equipped with an Axiocam 208 color camera, which is a versatile 8-megapixel color camera suitable for educational, documentation, and routine applications. The CMOS camera delivered crisp and detail-rich live images with high color fidelity, providing a full 4 k resolution at 30 frames per second (fps). Specifically, the fat globule size was evaluated microscopically as follows. Sample preparation-melting gently 1 g of ice cream sample (−20° C.) in 1 g of tap water (20° C.). A 10-microliter sample of the mixed ice cream sample was placed under the microscope and the distribution of the fat globules was evaluated and measured. In addition, a polarizer was used to detect the amount of sugar crystals still in the ice cream samples. In many transparent crystalline materials, the refractive index is different in p and s polarization axes-a phenomenon which is termed birefringence, and was observed using polarizing filters. In materials without birefringence, all light passes through the filters when filters are aligned and all light is blocked when crossed, but in birefringent materials, some light passes even when the filters are crossed. This creates a twinkle-of-stars effect on a black background when crystals are scattered in an amorphous medium. Sugar dissolved in water loses its crystalline structure and hence its birefringence and therefore cannot be seen in cross polarized illumination. The tested hypothesis was that the more sugar crystals that stay suspended in fat globules that have not melted—the sweeter the ice cream.

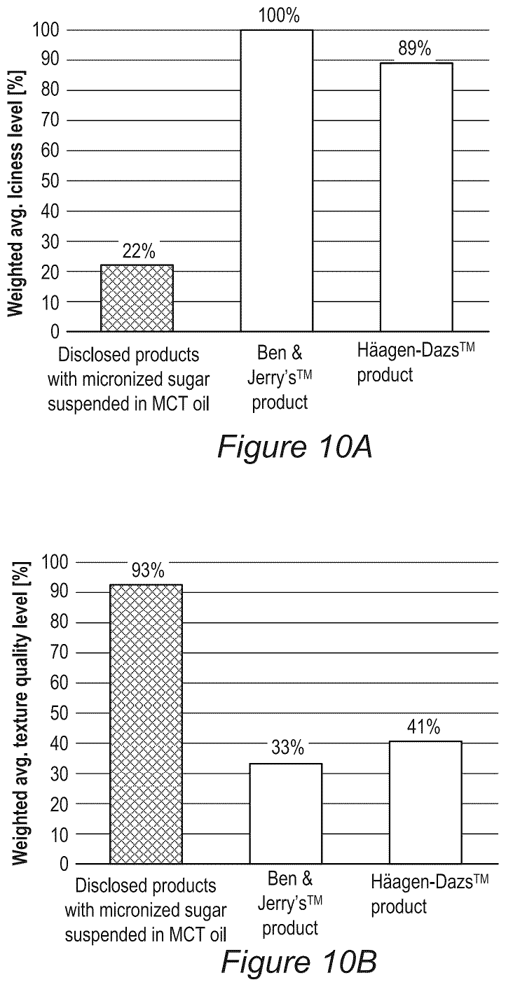

As disclosed below (see FIGS. 10A and 10B), a comparative taste test was performed between the disclosed Vanilla ice creams and the commercial ice creams-Haagen-Dazs™ Vanilla and Ben & Jerry's™ Vanilla Ice Cream. The first comparative tasting panel clearly showed a significant difference in the iciness level between commercial ice creams Ben&Jerry's™ Vanilla and Häagen-Dazs™ Vanilla, compared to the disclosed Vanilla ice cream. the iciness level of the disclosed ice cream was rated only 2.2 compared to 10 in Ben&Jerry's™ and 8.9 in Haagen-Dazs™ (see FIG. 10A). A second test showed that disclosed ice creams are sweeter compared to the reference (Ben & Jerry's™)-having a sweetness level of 8.67 versus 7.67 for the commercial product—although the disclosed ice cream contained almost 40% less sugar.

The following examines the effect of the fat component in the ice cream formulation on the iciness and sweetness levels.

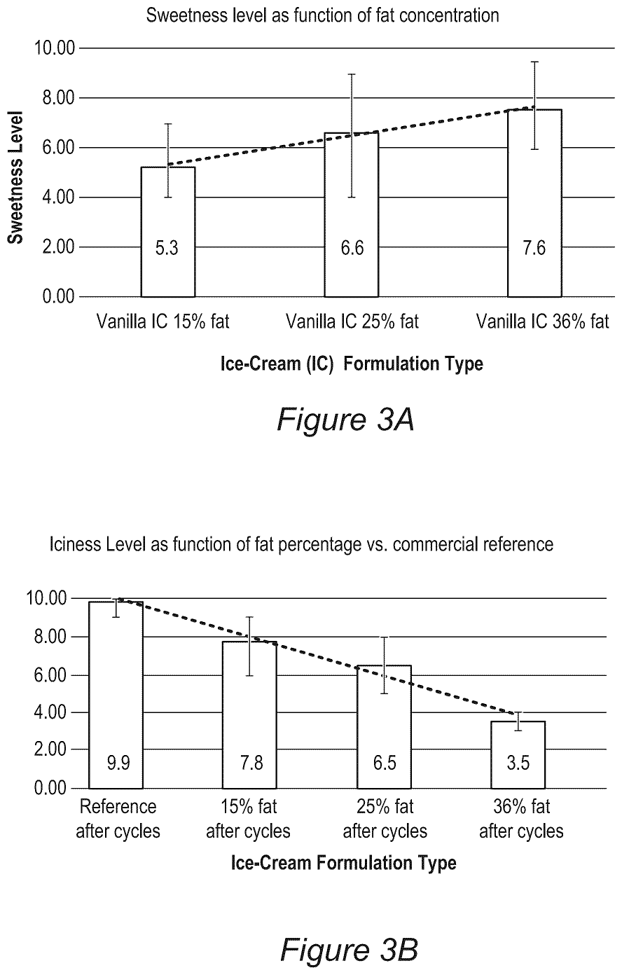

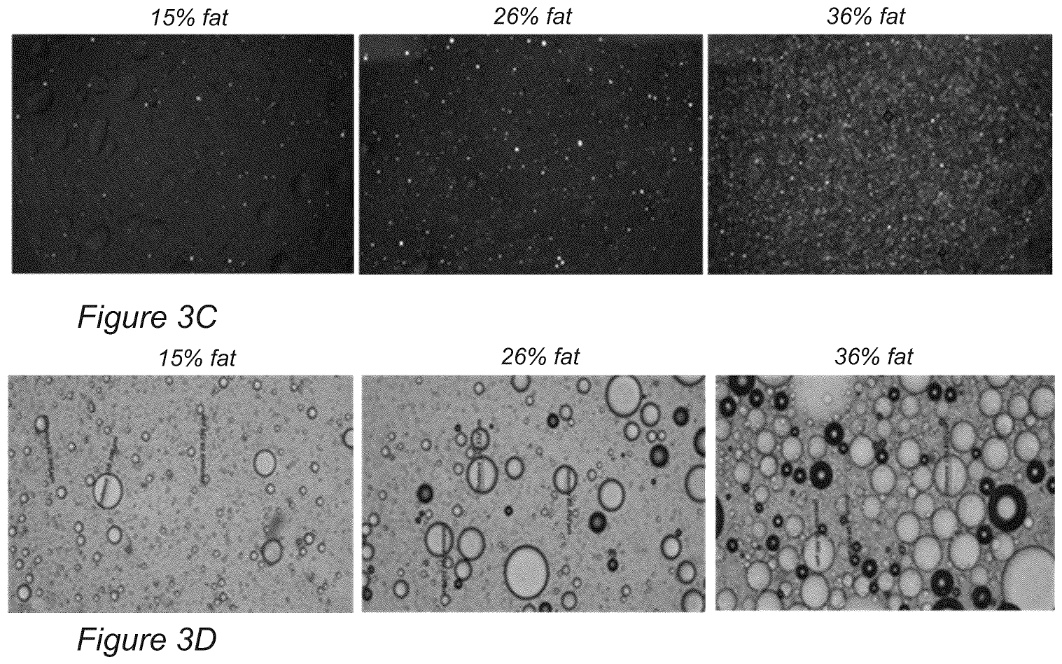

Fat Range—In the first part, the effect of the fat concentration in the disclosed ice creams on the sweetness and iciness level was examined (detailed samples data in Table 2B). FIG. 3A presents the Sweetness level as function of fat concentration (15%, 25%, 36%), while FIG. 3B presents the Iciness level of disclosed ice cream products on different fat concentrations (15%, 25%, 36%) after three cycles of thawing and freezing compared to commercial reference ice cream (15% fat) after three cycles of thawing and freezing (p value<0.5). In the results, there is a correlation between fat concentration in the ice cream formulation to sweetness level, when high fat concentration results in a sweeter ice cream, compared to low fat concentration that results in the least sweet ice cream (FIG. 3A). The contribution of the fat concentration of fat in the ice cream to the iciness level was examined, and a comparison was made between three disclosed ice cream samples in several fat concentrations (15%, 25%, 36%) to a commercial reference sample. All the samples underwent three cycles of thawing and freezing as described herein. There was a correlation between fat concentration and iciness level when high fat concentration results in low iciness level. Although the reference sample contains 15% fat, the iciness level was rated as 9.9 compared to disclosed ice cream with 15% fat that rated at 7.8 in the iciness level (FIG. 3B). FIG. 3C provides microscope images with polarizer ×5 of disclosed ice cream products (vanilla flavored), with 15% fat, 25% fat and 36% fat. White dots are crystalline sugar particles with birefringence that stand out in cross polarized illumination in dark field. It is noted that the high the fat content, the more microcrystalline sugar particles remain in the fat globules (rather than dissolve in the water phase as in prior art products). FIG. 3D provides microscope images ×10 of disclosed ice cream products (vanilla flavored), with 15% fat, 25% fat and 36% fat—showing directly the larger number of remaining fat globules—which, without being bound by theory, are suggested to reduce the level of iciness and maintain the level of sweetness (by keeping the sugar in microcrystalline form) after freeze-thaw cycles.

TABLE 2B
Compositions and nutritional values of tested ice
cream products for Fat Range tests (“Suspension”
denoting the micronized sugar in oil suspension).

| | Range - | Range | Range |
|---|---|---|---|
| Raw Material | 36% fat | 25% fat | 15% fat |
| Milk 3% | 29.5% | 41.3% | 69.1% |
| Cream 38% | 28.5% | 29.0% | 2.5% |
| Milk Powder | 0.9% | 0.9% | 0.9% |
| FABRRI stabilizer | 0.3% | 0.3% | 0.3% |
| SGF 70R fibers | 7.0% | 7.0% | 7.0% |
| Suspension 30% MCT | 29.5% | 0.00% | 0.00% |
| Suspension 40% MCT | 0.0% | 20.7% | 19.4% |
| Vanilla Paste | 0.9% | 0.9% | 0.9% |

| Nutritional | Range | Range | Range |
|---|---|---|---|
| Values | 36% fat | 25% fat | 15% fat |
| Energy (Kcal) | 397.6 | 298.4 | 210.2 |
| Total fat (g) | 36.3 | 25.0 | 15.0 |
| Saturated fat (g) | 31.5 | 20.0 | 13.7 |
| Trans fat (g) | 0.5 | 0.6 | 0.4 |
| Cholesterol (mg) | 36.0 | 37.6 | 9.9 |
| Sodium (mg) | 26.6 | 32.7 | 39.1 |
| Total | 13.8 | 13.8 | 13.8 |
| Carbohydrate (g) | | | |
| Sugars (g) | 12.5 | 12.5 | 12.5 |
| Dietary Fiber (g) | 5.0 | 5.0 | 5.0 |
| Sugar alcohol (g) | 0.0 | 0.0 | 0.0 |
| Proteins (g) | 1.8 | 2.2 | 2.6 |

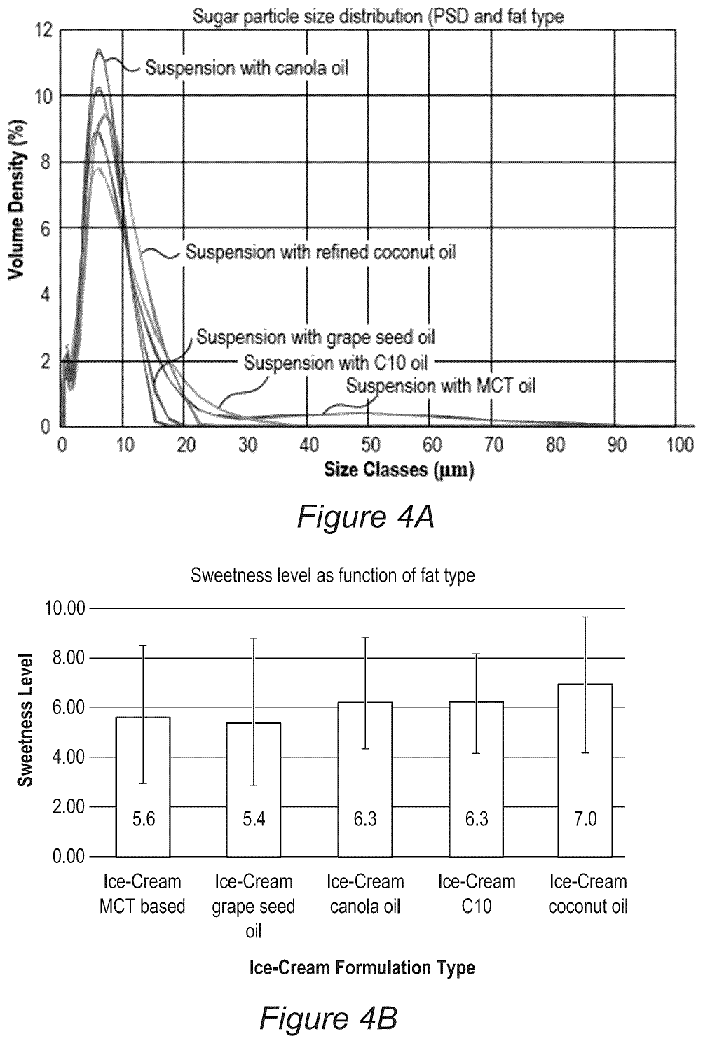

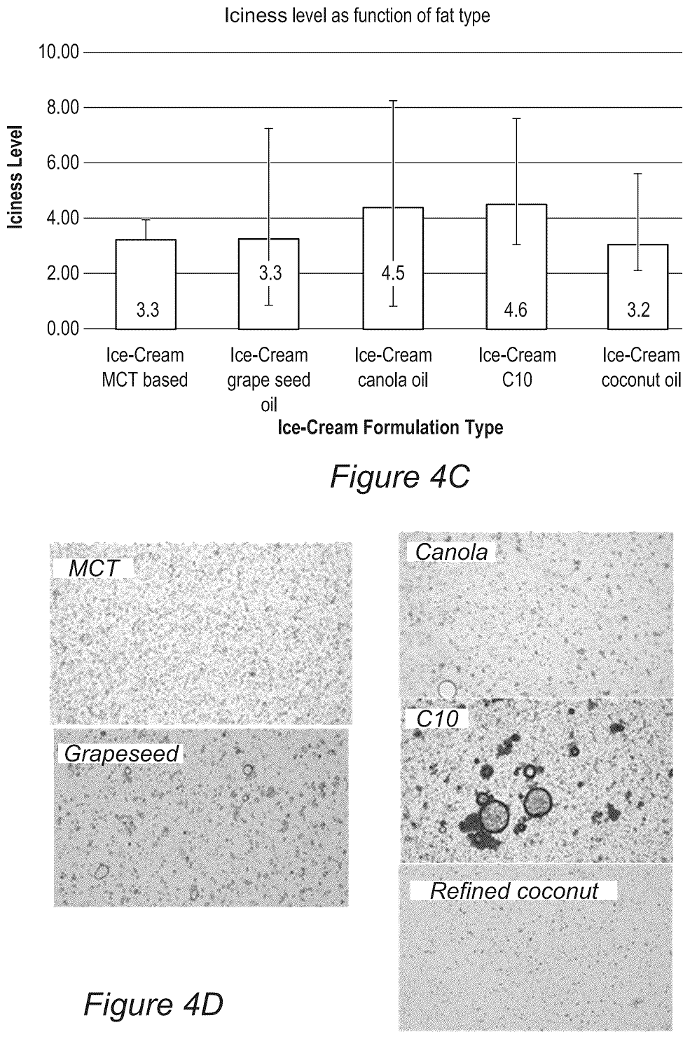

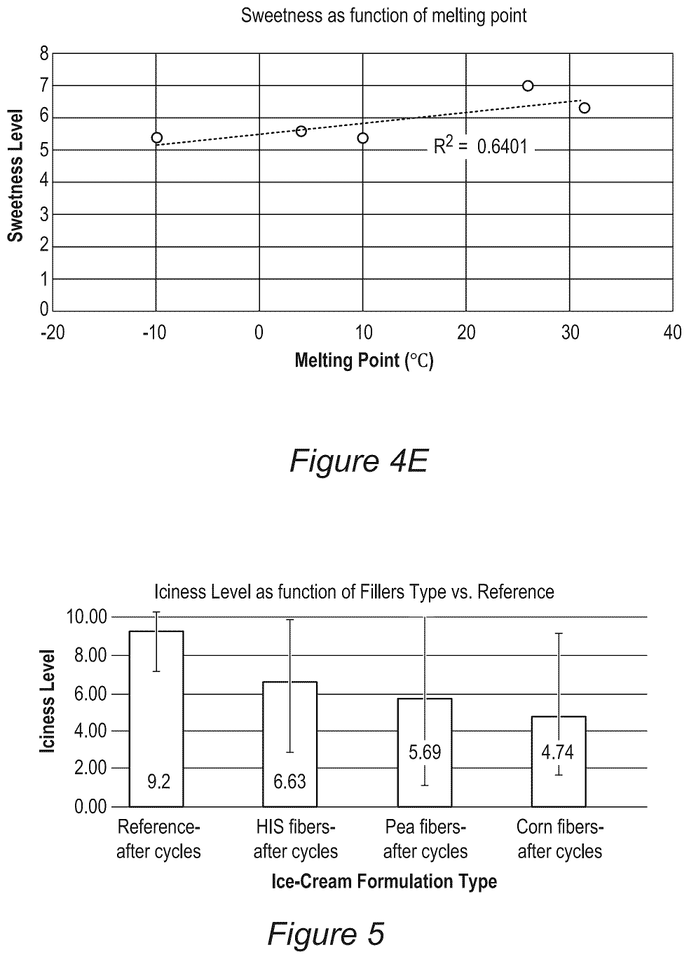

Fat Type—In the second part, the effect of fat type in disclosed ice cream products on the sweetness and iciness level was examined (detailed samples data in Table 2C). Five types of disclosed ice cream products were produced for this trial, each based on a different fat type. All the samples went through a PSD (Particle Size Distribution) test, with results shown in FIG. 4A-to ensure that the PSD did not affect the results, only the fat type. All samples have D90 percentile<15 μm and D50<10 μm, with the highest volume density provided by particles between 5-7 μm. FIG. 4B provides the results for the sweetness level of disclosed ice cream products depending on the type of fat—with coconut oil ice cream rated as the sweetest compared to grape seed oil ice cream, which was the least sweet sample. There was no difference in sweetness between the samples based on canola and C10 oil. FIG. 4C provides the results for the iciness level as a function of fat type, indicating that the disclosed ice cream sample based on coconut oil was rated 3.2, with the lowest score of iciness level. The samples based on MCT oil and grape seed oil were rated right next, with a 3.3 iciness level, while the sample with the highest iciness level score was based on C10 oil with a 4.6 iciness level. FIG. 4D provides corresponding microscope images of disclosed ice creams samples based on different oils—indicating the finer structure of disclosed ice creams based on MCT oil and refined coconut oil, somewhat coarser structures of disclosed ice creams based on grape seed oil and canola oil, and coarser structure of disclosed ice creams based on C10 oil—which correspond to the Iciness measurements in relating finer structure to a reduced degree of iciness.

TABLE 2C
Compositions and nutritional values of tested ice cream products for Fat
Type tests (“Suspension” denoting the micronized sugar in oil suspension).

| | Type of Fat in the oil | | | | |
|---|---|---|---|---|---|
| | suspension of micronized sugar | | | | |
| Raw Material | MCT | C10 | Grape Seed | Canola | Coconut |
| Milk 3% | 41.3% | 41.3% | 41.3% | 41.3% | 41.3% |
| Cream 38% | 29.0% | 29.0% | 29.0% | 29.0% | 29.0% |
| Milk Powder | 0.9% | 0.9% | 0.9% | 0.9% | 0.9% |
| FABRRI stabilizer | 0.3% | 0.3% | 0.3% | 0.3% | 0.3% |
| SGF 70R fibers | 7.0% | 7.0% | 7.0% | 7.0% | 7.0% |
| Suspension 40% MCT | 20.7% | | | | |
| Vanilla Paste | 0.9% | 0.9% | 0.9% | 0.9% | 0.9% |
| Suspension 40% C10 | | 20.7% | | | |
| Suspension 40% | | | 20.7% | | |
| Grape Seed Oil | | | | | |
| Suspension 40% | | | | 20.7% | |
| Canola Oil | | | | | |
| Suspension 40% | | | | | 20.7% |
| Refined Coconut Oil | | | | | |

| | Type of Fat in the oil | | | | |
|---|---|---|---|---|---|
| | suspension of micronized sugar | | | | |
| | | | | Grape | |
| Nutritional Values | MCT | C10 | Canola | Seed | Coconut |
| Energy (Kcal) | 298.39 | 298.39 | 289.47 | 298.39 | 297.27 |
| Total fat (g) | 25.04 | 25.04 | 24.04 | 25.04 | 24.91 |
| Saturated fat (g) | 20.03 | 7.64 | 8.51 | 8.83 | 18.26 |
| Trans fat (g) | 0.61 | 0.61 | 0.61 | 0.61 | 0.61 |
| Cholesterol (mg) | 37.60 | 37.60 | 37.60 | 37.60 | 37.60 |
| Sodium (mg) | 32.67 | 32.67 | 32.67 | 32.67 | 32.67 |
| Total | 13.79 | 13.79 | 13.79 | 13.79 | 13.79 |
| Carbohydrate (g) | | | | | |
| Sugars (g) | 12.54 | 12.54 | 12.54 | 12.54 | 12.54 |
| Dietary Fiber (g) | 5.04 | 5.04 | 5.04 | 5.04 | 5.04 |
| Sugar alcohol (g) | 0.00 | 0.00 | 0.00 | 0.00 | 0.00 |
| Proteins (g) | 2.17 | 2.17 | 2.17 | 2.17 | 2.17 |

To explore the possible reasons for these effects, the oils were characterized by parameters like fatty acid composition, viscosity, and melting point—as listed in Table 2D.

TABLE 2D
Fatty acid data - melting point (° C.), viscosity
(cP), and fatty acid composition (MCT, C10, grape
seed oil, refined coconut oil, canola oil).

| | Refined | Grape | Canola | | |
|---|---|---|---|---|---|
| | coconut oil | Seed Oil | Oil | C10 | MCT |
| Melting point ° C. | 26 | 10 | (−10) | 31.5 | 4 |
| Viscosity (cP) | 60 | 87.8 | 78.2 | 17 | 27-33 |

Fatty acid composition (wt. %)

| | | | | | |
|---|---|---|---|---|---|
| C6:0 | 0.41 | | | | |
| C8:0 | 6.61 | | | | 55 |
| C10:0 | 5 | | | 100 | 45 |
| C12:0 | 48.14 | | | | |
| C14:0 | 17.88 | | 0.06 | | |
| C16:0 | 8.88 | 7.1 | 3.75 | | |
| C16:1 | | | 62.41 | | |
| C17:0 | | | 0.04 | | |
| C18:0 | 3.26 | 4.24 | 1.87 | | |
| C18:1 | 7.63 | 21.9 | | | |
| C18:2 | 2.19 | 66 | 20.12 | | |
| C18:3 | | 0.29 | 8.37 | | |
| C20:0 | | 0.15 | 0.64 | | |
| C20:1 | | 0.18 | 1.54 | | |
| C20:2 | | | 0.11 | | |
| C20:4 | | | | | |
| C22:0 | | | 0.35 | | |
| C24:0 | | | 6.98 | | |
| C24:1 | | | 0.26 | | |
| SFA | | 11.5 | | | |
| MUFA | | 22.2 | 64.42 | | |
| PUFA | | 66.3 | 28.6 | | |

FIG. 4E provides the only correlation that was observed-between the melting point of the oil and the degree of sweetness it provides.

The following summarizes the results of the Fat Component Examination concerning the iciness level vs commercial reference (where both disclosed ice cream samples and the reference ice cream underwent thawing and freezing cycles) and sweetness level. Ice creams typically contain 10-16% fat, making fat an important ingredient that affects product hardness, shape retention, and melting resistance after hardening. Reduction of fat in ice cream can thus lead to textural defects such as iciness and coarseness, brittle body, and shrinkage. The test show that in disclosed ice cream samples—as the level of fat increases, the level of iciness decreases. Without being bound by theory, elevating the fat percentage may cause a decrease in water content and an increase in solids, inhibiting the formation of ice crystals and the development of an icy texture in ice cream. However, disclosed ice cream sample contains 15% fat and was still less icy than the reference ice cream containing the same amount of fat (see FIG. 3B).

When the effect of the fat concentration in disclosed ice cream on the sweetness was examined, it could be seen that an increase in the fat percentage would result in a sweeter ice cream (see FIG. 3A). Without being bound by theory, the micronized sugar in oil suspension may have a decreasing enhancement of sweetness as more free water are present in the ice cream to which the suspension is exposed, possibly due to melting of the microscopic sugar crystals in the free water. The higher the fat percentage, the more protected may be the micronized sugar inside the fat globules—resulting in further enhancement of sweetness by lower amounts of sugar. In addition, as the fat percentage increases—the water percentage decreases, there is less kinetics and the ability to dissolve the micronic sugar in water decreases. It can be clearly seen in the microscope images (see FIG. 3C) that as the fat percentage increases, the presence of undissolved sugar crystals increases (in the picture—the sparkling white dots are sugar crystals).

After studying the effect of the fat concentration on the iciness and sweetness of the ice cream, the effect of the type of fat the ice cream is made of on these two parameters was also studied. It was shown that despite the low freezing temperature of MCT oil, which is very close to the freezing temperature of the water, MCT oil still allows the emulsion to remain stable down to zero degrees and makes it function as an anti-freeze. Changing the type of oil/fat did not affect significantly on the iciness resistance (all iciness level values were lower than 5) (see FIG. 4C). It was shown that adding oil/fat in different fatty acid compositions and different viscosity did not significantly affect the iciness resistance (see FIG. 4C and Table 2D).

The type of fat did affect the sweetness of the ice cream, and a linear relationship was found between the melting point of the fat and the level of sweetness obtained. The higher the melting point, the higher the level of sweetness. Without being bound by theory, it is suggested that the disclosed micronic sugar was trapped inside the fat globules, and when the ice cream was put into the oral cavity, the globules melted, and the microscopic sugar crystals reached the taste buds, causing the tasters to sense the sweet taste. The higher the melting temperature of the fat, the slower the globules were destroyed and were slower to lose the sugar crystals within them. Also, the closer the melting point was to the temperature in the oral cavity, the more the sugar was released quickly and effectively, and the feeling of sweetness when eating the ice cream increased (see FIG. 4E).

The following examines the effect of the filler component in the ice cream formulation on the iciness levels.

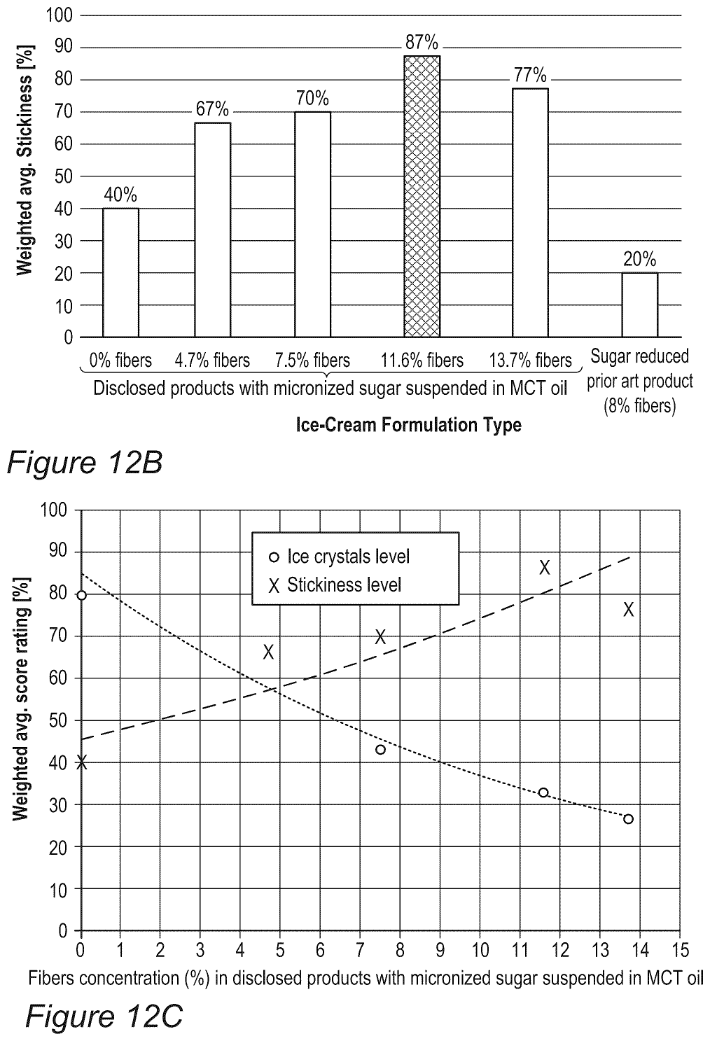

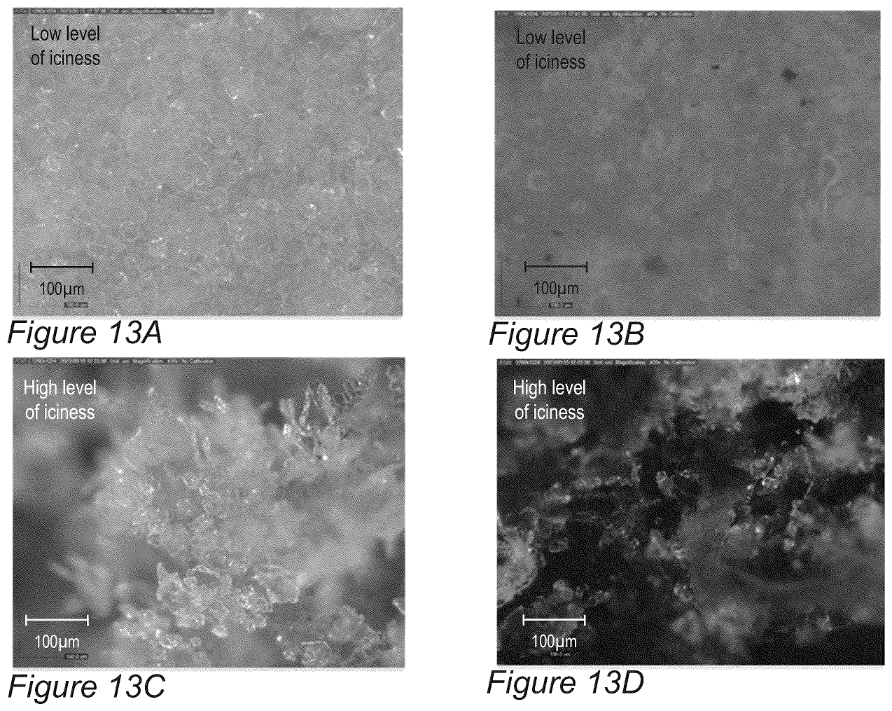

Fillers Range-In the first part, the effect of the filler concentration in disclosed ice cream products on the iciness level was examined (detailed samples data in Table 2E). Disclosed ice cream products with a gradient of fiber concentrations were tasted and compared to an Israeli commercial low sugar high fiber ice cream Glidal™. FIG. 12A (below) illustrates the clear correlation that was observed between the increase in the percentage of fiber and the level of iciness in disclosed ice cream products. The commercial low sugar Ice cream Glidal™ was exceptional in terms of the iciness level as a function of fiber percentage. Glidal™ with 8% of fibers Rated 10 in iciness level which was also observed in the microscope images provided in FIGS. 13A-13D (see below), compared to disclosed ice cream products with 7.5% fibers that rated only 4.3 in iciness level.

TABLE 2E
Compositions and nutritional values of tested ice cream
products for Filler (Fibers) range tests (“Suspension”
denoting the micronized sugar in oil suspension).

| | Fibers Range | | | | |
|---|---|---|---|---|---|
| Raw Material | 0% | 4.7% | 7.5% | 11.6% | 13.7% |
| Milk 3% | 32.7% | 32.0% | 30.9% | 28.9% | 28.0% |
| Cream 38% | 32.7% | 32.0% | 30.9% | 28.9% | 28.0% |
| Milk Powder | 0.9% | 0.6% | 0.8% | 0.8% | 0.6% |
| FABRRI stabilizer | 0.7% | 0.7% | 0.7% | 0.7% | 0.7% |
| SGF 70R fibers | | 4.7% | 7.1% | 11.6% | |
| Suspension 40% MCT | | | | | 13.70% |
| Suspension 30% MCT | 33.0% | 30.0% | 29.7% | 29.2% | 28.9% |

| | Fibers Range | | | | |
|---|---|---|---|---|---|
| Nutritional Values | 0% | 4.7% | 7.1% | 11.6% | 13.7% |
| Energy (Kcal) | 379.12 | 377.00 | 376.14 | 374.51 | 373.70 |
| Total fat (g) | 35.84 | 34.56 | 33.95 | 32.76 | 32.20 |
| Saturated fat (g) | 30.19 | 29.24 | 28.79 | 27.93 | 27.53 |
| Trans fat (g) | 0.65 | 0.61 | 0.59 | 0.55 | 0.53 |
| Cholesterol (mg) | 42.61 | 40.09 | 38.83 | 36.38 | 35.24 |
| Sodium (mg) | 29.52 | 27.93 | 27.15 | 25.59 | 24.86 |
| Total | 12.29 | 13.12 | 13.53 | 14.34 | 14.71 |
| Carbohydrate (g) | | | | | |
| Sugars (g) | 12.28 | 12.28 | 12.28 | 12.29 | 12.29 |
| Dietary Fiber (g) | 0.28 | 3.59 | 5.22 | 8.38 | 9.85 |
| Sugar alcohol (g) | 0.00 | 0.00 | 0.00 | 0.00 | 0.00 |
| Proteins (g) | 2.02 | 1.91 | 1.86 | 1.75 | 1.70 |

Fillers Type—In the second part, the effect of filler type in disclosed ice cream products on the iciness level was examined, and a comparison was made between three disclosed ice cream product samples with different filler types (corn fibers, pea fibers, inulin HIS fibers) to a commercial reference sample (detailed samples data in Table 2F). All the samples underwent three cycles of thawing and freezing as described herein. As presented in FIG. 5—the reference was rated with the highest iciness score of 9.2, while all disclosed ice cream product samples were rated 6.6 and less (p value<0.5)—indicating that in contrast to prior art products, addition of fibers is effective in reducing iciness in disclosed ice cream product, which is a surprising result.

TABLE 2F
Compositions and nutritional values of tested ice cream products for Filler (Fibers)
Type tests (“Suspension” denoting the micronized sugar in oil suspension).

| | Fillers Type | | | | |
|---|---|---|---|---|---|
| | SGF 70R | | Inulin HSI | Whey | Pea |
| Raw Material | corn fibers | Pea fibers | fibers | Protein | Protein |
| Milk 3% | 41.30% | 41.30% | 41.30% | 41.3% | 41.3% |
| Cream 38% | 29.00% | 29.00% | 29.00% | 29.0% | 29.0% |
| Milk Powder | 0.90% | 0.90% | 0.90% | 0.9% | 0.9% |
| FABRRI stabilizer | 0.30% | 0.30% | 0.30% | 0.3% | 0.3% |
| SGF 70R fibers | 7.00% | | | | |
| Suspension 40% | 20.70% | 20.70% | 20.70% | 20.7% | 20.7% |
| Vanilla Paste | 0.90% | 0.90% | 0.90% | 0.9% | 0.9% |
| Inulin HSI fibers | | | 7.00% | | |
| Pea fibers | | 7.00% | | | |
| Whey Protein | | | | 7.0% | |
| Pea protein | | | | | 7.0% |
| | Fillers Type | | | | |
| | SGF 70R | | Inulin HIS | Whey | Pea |
| Nutritional Values | corn fibers | Pea fibers | fibers | protein | protein |
| Energy (Kcal) | 298.39 | 300.56 | 296.85 | 309.73 | 310.64 |
| Total fat (g) | 25.04 | 25.06 | 25.04 | 25.44 | 25.67 |
| Saturated fat (g) | 20.03 | 20.03 | 20.03 | 20.38 | 20.17 |
| Trans fat (g) | 0.61 | 0.61 | 0.61 | 0.61 | 0.61 |
| Cholesterol (mg) | 37.60 | 37.60 | 37.60 | 46.77 | 37.60 |
| Sodium (mg) | 32.67 | 32.70 | 32.67 | 44.50 | 32.81 |
| Total | 13.79 | 14.84 | 12.81 | 12.95 | 12.09 |
| Carbohydrate (g) | | | | | |
| Sugars (g) | 12.54 | 12.02 | 12.79 | 12.93 | 12.02 |
| Dietary Fiber (g) | 5.04 | 3.29 | 6.16 | 5.32 | 0.24 |
| Sugar alcohol (g) | 0.00 | 0.00 | 0.00 | 0.00 | 0.00 |
| Proteins (g) | 2.17 | 2.45 | 2.17 | 7.35 | 7.89 |

The following summarizes the results of the Filler Component Examination. Testing the fiber content effect on iciness showed that the higher the fiber content the higher the resistance to iciness. Without being bound by theory, these findings suggest that the parameter that most affected the resistance to temperature fluctuations was the addition of fibers to the ice cream (in contrast to prior art products, in which such addition of fibers did not affect the resistance to iciness). It should be noted that the graph behavior (see FIG. 12A below) was asymptotic which may suggest an optimal fiber concentration. Moreover, the opposite correlation for the stickiness parameter was observed, suggesting that the optimal fiber content may be optimized with respect to both iciness and stickiness. These results demonstrate that disclosed ice creams with a higher percentage of 7.5% of fibers showed good resistance iciness but a high level of stickiness, which may not be desirable in terms of the ice cream texture in some types of ice cream products. The inventors suggest that the optimal fiber concentration to avoid stickiness but maintain the resistance to iciness is about 7 wt %, or possibly within the range of 5-12 wt %, and possibly depending on the used type of fibers.

To understand if the only parameter that affects the ice crystal growth is the fibers, a commercial ice cream with reduced sugar and added fibers (referred to below as “Glidal™”) was tasted. Surprisingly, the results showed that iciness was very different compared to disclosed ice cream products with similar fiber content (see FIG. 12A below). These findings were also verified by microscope images where the non-homogenous growth of the ice crystals of this ice cream compared to the disclosed ice cream was observed (FIGS. 13A-13D).

Similar effects of adding fibers to disclosed ice cream products to enhance resistance to iciness were confirmed in three different types of fillers that were tested against a commercial reference. It was showed that even though there was an effect of the type of fiber on the iciness level, the durability was still maintained when the maximum iciness values of 6.6 were obtained for disclosed ice creams, while for the reference ice cream, a significantly higher iciness value of 9.2 is obtained (see FIG. 5).

It is known that ice crystallization is strongly dependent on the extent of freezing point depression and the percentage of bound water. The present disclosure demonstrated the unique disclosed ice cream properties provide an enhancement of iciness resistance against iciness caused by temperature fluctuations. Moreover, the combined effects in the results for fat, sugar and fillers indicate that the exceptional resistance to iciness of disclosed ice cream products may result from combinations of factors such as type of oil and fat, the content and size of sugar particles (see below), the fiber content, and the manufacturing protocol (see below), all of which being significantly different from regular ice cream.

The following examines the effect of the sugar component in the ice cream formulation on the iciness and sweetness levels.

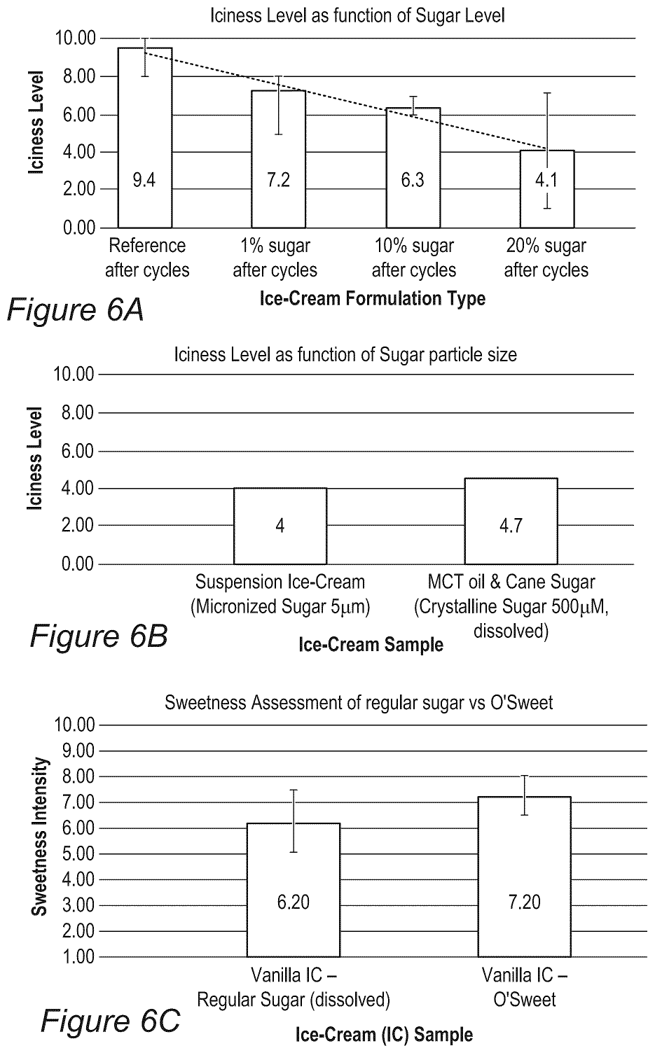

Sugar Range. In the first part, the effect of the sugar concentration in disclosed ice cream products on the iciness level was examined. Three disclosed ice cream products samples were examined in three sugar concentrations (1%, 10%, 20%) compared to a commercial reference sample. All the samples underwent three cycles of thawing and freezing as described herein. As illustrated in FIG. 6A, a correlation was found between sugar concentration and iciness level, with high sugar concentration resulting in low iciness level (p value<0.5). Although the reference sample contained 20% sugar, the iciness level was rated high as 9.4 compared to disclosed ice cream products with 20% sugar rated only 4.1 iciness level. This result indicates that the presence of sugar as microcrystalline sugar within the oil suspension is much less liable to cause iciness, than prior art use of sugar.

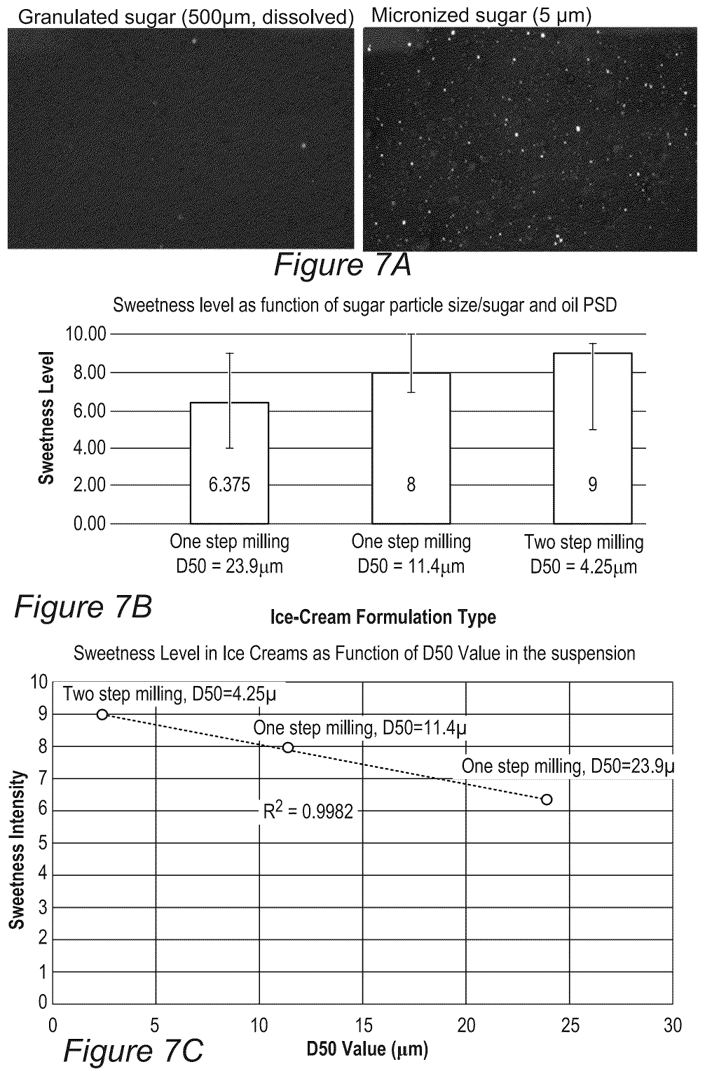

Sugar particle size. In this part, the effect of the sugar particle size on the iciness was examined (detailed samples data in Table 2G). As indicated in FIG. 6B, no significant difference in iciness level was observed between ice cream based on crystalline sugar to ice cream based on micronized sugar, indicating that the change to micronized oil alone was not sufficient to improve resistance to iciness. As illustrated in FIG. 6C, the sweetness level of disclosed ice cream based on the oil suspension of micronized sugar was higher compared to the ice cream based on crystalline sugar. FIG. 7A provides a comparison of microscope images with polarizer ×5, between a prior art ice cream sample based on granulated sugar (500 μm) which was dissolved into the water phase, and a sample from disclosed ice cream products based on micronized sugar (5 μm) suspended in the fat globules (from the suspending oil). The photos showed glowing dots inside the globules when viewed under polarized lighting with cross-polarized filters, indicating the presence of crystalline sugar in a stable emulsion of fat in water. This is different from normal ice creams, where the sugar is molecularly dissolved in water and appears dark under polarized illumination. FIG. 7A thus illustrates the presence of micronized sugar within the fat globules in the ice cream mix versus completely dissolved sugar in the regular (prior art) ice cream mix. The findings provide evidence that using micronized sugar in oil suspensions is effective to maintain sweetness and reduce iciness although the sugar was not dissolved in the water phase, and that the sugar survives in crystalline form in the mix, enhancing its sweetness.

TABLE 2G
Compositions and nutritional values of tested ice cream products for Sugar Type tests with
granulated sugar as in the prior art, micronized sugar in oil suspension as disclosed herein
and different sugar PSDs (“Suspension” denoting the micronized sugar in oil suspension).

| | | | Two step | | |
|---|---|---|---|---|---|
| | Granulated | | fine milling | Single | |
| | Sugar | Suspension | suspension | milling suspension | |
| Raw Material | (dissolved) | D50 < 5 μm | D50 = 4.25 μm | D50 = 11.4 μm | D50 = 23.9 μm |
| Milk 3% | 41.3% | 41.3% | 41.3% | 41.3% | 41.3% |
| Cream 38% | 29.0% | 29.0% | 29.0% | 29.0% | 29.0% |
| Milk Powder | 0.9% | 0.9% | 0.9% | 0.9% | 0.9% |
| FABRRI stabilizer | 0.3% | 0.3% | 0.3% | 0.3% | 0.3% |
| SGF 70R fibers | 7.0% | 7.0% | 7.0% | 7.0% | 7.0% |
| Vanilla Paste | 0.9% | 0.9% | 0.9% | 0.9% | 0.9% |
| Suspension 40 wt % | | 20.7% | 20.7% | 20.7% | 20.7% |
| sugar in MCT oil (one | | | | | |
| and two milling steps) | | | | | |
| Sugar | 8.30% | | | | |
| MCT Oil | 12.40% | | | | |

| | | | |
|---|---|---|---|
| | | Two step fine | |
| | Granulated | milling | Single |
| Nutritional | Sugar | suspension | milling suspension |

| Values | (dissolved) | D50 = 4.25 μm | D50 = 11.4 μm | D50 = 4.25 μm |
|---|---|---|---|---|
| Energy (Kcal) | 298.39 | 298.39 | 298.39 | 298.39 |
| Total fat (g) | 25.04 | 25.04 | 25.04 | 25.04 |
| Saturated fat (g) | 20.03 | 20.03 | 20.03 | 20.03 |
| Trans fat (g) | 0.61 | 0.61 | 0.61 | 0.61 |
| Cholesterol (mg) | 37.60 | 37.60 | 37.60 | 37.60 |
| Sodium (mg) | 32.67 | 32.67 | 32.67 | 32.67 |
| Total | 13.79 | 13.79 | 13.79 | 13.79 |
| Carbohydrate (g) | | | | |
| Sugars (g) | 12.54 | 12.54 | 12.54 | 12.54 |
| Dietary Fiber (g) | 5.04 | 5.04 | 5.04 | 5.04 |
| Sugar alcohol (g) | 0.00 | 0.00 | 0.00 | 0.00 |
| Proteins (g) | 2.17 | 2.17 | 2.17 | 2.17 |

Sugar Range. In this part, the effect of sugar levels on sweetness and the iciness was examined (detailed samples data in 2H). Three samples of ice cream were prepared, and in each sample, a different sugar PSD (sugar in oil) was incorporated into the ice cream. FIGS. 7B and 7C illustrate the observed correlation between particle size/PSD and sweetness level when the ice cream with the smallest particle size (D50=4.25 μm) was the sweetest sample.

TABLE 2H
Compositions and nutritional values of tested ice
cream products for Sugar Range tests (“Suspension”
denoting the micronized sugar in oil suspension).

| Raw Material | Range - 1% | Range - 10% | Range - 20% |
|---|---|---|---|
| Milk 3% | 53.4% | 44.0% | 33.0% |
| Cream 38% | 22.0% | 22.0% | 23.0% |
| Milk Powder | 0.9% | 0.9% | 0.9% |
| FABRRI stabilizer | 0.3% | 0.3% | 0.3% |
| SGF 70R fibers | 7.0% | 7.0% | 7.0% |
| Vanilla Paste | 0.9% | 0.9% | 0.9% |
| MCT Oil | 15.0% | 5.0% | |
| Suspension 50% MCT | 0.5% | 20.0% | |
| Suspension 57% MCT | | | 35.0% |

| Nutritional | Sugar | Sugar | Sugar |
|---|---|---|---|
| Values | Range - 1% | Range - 10% | Range - 20% |
| Energy (Kcal) | 274.45 | 305.18 | 341.52 |
| Total fat (g) | 25.22 | 25.10 | 25.31 |
| Saturated fat (g) | 21.05 | 21.03 | 21.22 |
| Trans fat (g) | 0.57 | 0.53 | 0.49 |
| Cholesterol (mg) | 30.68 | 29.86 | 30.01 |
| Sodium (mg) | 36.65 | 32.10 | 26.88 |
| Total | 6.91 | 15.46 | 24.74 |
| Carbohydrate (g) | | | |
| Sugars (g) | 5.66 | 14.21 | 23.48 |
| Dietary Fiber (g) | 5.04 | 5.04 | 5.04 |
| Sugar alcohol (g) | 0.00 | 0.00 | 0.00 |
| Proteins (g) | 2.42 | 2.12 | 1.77 |

The following summarizes the results of the Sugar Component Examination. The concentration of sugar in disclosed ice cream products was found to affect the level of iciness and the iciness resistance, with a high sugar concentration resulting in a creamy and not-icy ice cream, and as the concentration of sugar decreased, the level of iciness increased and the ability to resist iciness decreased. Without being bound by theory it is suggested that this fact is consistent with the understanding that a high concentration of solutes in the ice cream formulation may help deal with resistance to iciness. However, comparing disclosed ice cream samples in this section to a commercial reference, suggests that even with a minimal sugar concentration (1%), the iciness level was almost 2 points lower than the commercial reference, which contains 20% sugar. This comparison illustrates the remarkable advantage that disclosed ice cream products have over the commercial reference ice cream; even at low solute concentrations, disclosed ice cream products still exhibit an impressive ability to deal with temperature fluctuations and iciness resistance (see FIG. 6A).

However, it was noted that under specific conditions, replacement of the micronized sugar particles in disclosed ice cream products by crystalline cane sugar in our ice cream recipe did not result in a loss of the high resistance to temperature fluctuations (see FIG. 6B). However, disclosed ice cream was sweeter compared to the crystalline sugar ice cream (see FIG. 6C). Also, the particle size of the sugar in oil was found to affect the sweetness level of ice cream, where smaller sugar particle size contributed to the sweetness increase in the ice cream (see FIGS. 7B and 7C). Without being bound by theory it is suggested that this finding is consistent with the hypothesis that reducing the sugar crystal size along with increasing the surface area of the sugar particles by micronizing them—contributes to sweetness increase and illustrates the advantage of using the suspension of micronized sugar in oil—as a sweetener in ice cream.

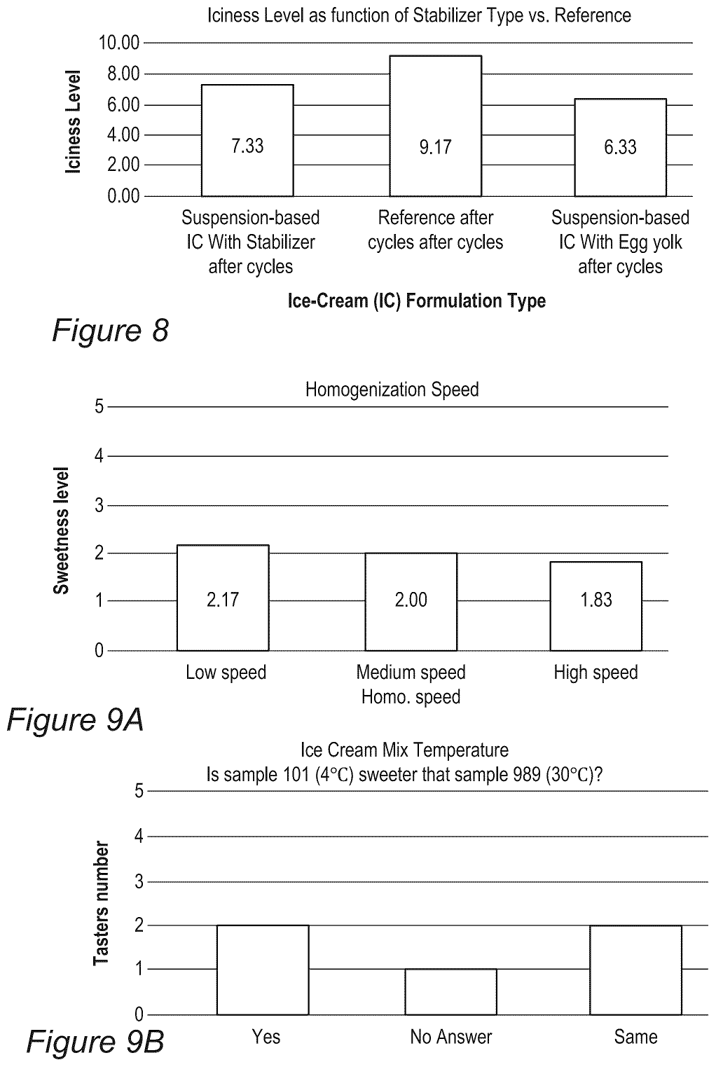

Stabilizer. In this part, the effects on the iciness level of various stabilizer components in disclosed ice cream formulation were examined. Two disclosed ice cream product samples were examined, with one sample based on a stabilizer that contains few stabilizer agents (Thickeners sodium alginate (E 4010), carrageenan (E 407), locust bean gum (E410), guar gum (E412), sodium carboxymethyl cellulose (E466), Emulsifier mono and diglycerides of fatty acid (E471)), and the second sample based on egg yolks. These two samples were compared to a commercial reference based on egg yolks. All the samples underwent three cycles of thawing and freezing as described herein. FIG. 8 illustrates that both disclosed ice cream product samples had relatively low iciness level compared to the reference sample that was with iciness level of 9.2 (p value<0.5).

The following summarizes the results of the examination of the effect of the stabilizer and the type of stabilizer on the iciness resistance. Two types of stabilizers were tested in disclosed ice cream samples-stabilizer powder purchased from the Fabbri™ company and egg yolks used as a stabilizer. These two samples were tested against a reference ice cream in which egg yolks are used as a stabilizer without the addition of additional powders. In the disclosed ice cream with the egg yolks, the level of iciness obtained was the lowest, 1 point above it in the disclosed sample with the powdered stabilizer. On the other hand, the reference ice cream, which is also based on egg yolks (compared with the first disclosed sample, which was rated at the lowest level of iciness among the samples), was rated at an extremely high level of iciness. This finding illustrates that the stabilizer alone (from which the basic formulation of the disclosed ice cream was composed) was not the factor that gave disclosed ice creams the advantage of resistance to iciness because otherwise a similar result between the egg yolk based disclosed ice cream sample and the reference sample would have been expected (see FIG. 8).

The following summarizes the conclusions and characterization of disclosed ice cream products. Disclosed ice cream formulations demonstrate a repeatable and constant resistance to iciness and increased sweetness versus commercial ice creams. The total amount of fat was found to contribute significantly to sweetness and iciness resistance. The higher the fat percentage, the greater the effect, yet it was not the only parameter affecting the uniqueness of the disclosed ice cream durability. The type of oil was found to contribute to iciness resistance against freeze-thaw cycles applied to the ice cream samples, as a function of the melting point of the various oils. Use of micronized sugar in oil suspensions, with reduced sugar crystal sized, was found to contribute to the increased sweetness and illustrated the advantage of using such suspensions as sweeteners in ice cream. Disclosed ice cream products showed impressive temperature fluctuation tolerance and iciness resistance at low solute concentrations, surpassing commercial reference ice cream at higher solute concentrations.

The fiber concentration within the formula was found to significantly contribute to iciness resistance in freeze-thaw cycles of disclosed ice creams. The fiber concentration within other, prior art ice creams did not contribute to iciness resistance in freeze-thaw cycles of ice cream. It may be concluded that fiber concentration affected iciness resistance only in disclosed ice cream products, which included the complete formulation and/or were produced according to the production process described herein, which are both unique to disclosed ice creams. Furthermore, it was found that while the type of fiber affected the iciness level, disclosed ice creams still maintained durability even with less suitable fibers compared to the reference ice cream (with the same type of fibers). The ice cream stabilizer was not found to give disclosed ice creams the advantage of resistance to iciness. The polarized microscope photos demonstrated that crystalline sugar stayed within the fat globules in disclosed ice cream mixed, as opposed to sugar being completely dissolved in regular, prior art mixes-which further indicates the effectiveness of using the suspensions of micronized sugar in oil in increasing the sweetness profile in disclosed ice creams.

Additional experimental results are provided, concerning the effects and adjustments of the production process, described herein (see FIGS. 1A-1D). Specifically, the presence of sugar in micronized form within oil globules from the suspension was studied. This presence of micronized sugar in fat globules in the final product as disclosed, stands in contrast to commercial products in which sugar is introduced as much larger, granular crystals, which are exposed to and fully dissolved in free water in the emulsion, and is hence present at the molecular scale in the water phase. The following experiments were conducted to investigate the use of the suspensions of micronized sugar in oil during the production process of disclosed ice cream products. Specifically, the aging stage 106, the temperature of the mixture to which the suspension was added, and the duration and intensity of gentle homogenization stage 112 were investigated with respect to their effects on the sweetness of the final product.

All the ice creams in the experiment were prepared according to the same basic recipe. To simulate the industrial production process (heating with a bottom stirrer, sealed container with a lid to prevent liquid evaporation), all the ice cream masses were prepared with a high-speed Thermomix™. The ice cream machine STAFF BTE150™ was used as an integral component in ice cream production. This machine functions by stirring the ice cream mixture while simultaneously freezing it, incorporating air to create a smooth and creamy texture. It maintains consistent temperatures, promoting the gradual formation of ice crystals for optimal texture and taste. Thermomix TM6™ was used as a versatile kitchen appliance that consolidates numerous cooking functions into a single device. With features including precise temperature control and robust blades capable of high-speed mixing, it performs various culinary tasks. In this experiment, the Thermomix™ was employed for two primary purposes: (1) to homogenize all the ingredients, creating a uniform ice cream mixture, and (2) to heat the ice cream mixture to a temperature range of 80-90° C., enabling the stabilizer to activate and dissolve the fibers within the mixture.

Sensory analysis was carried out by tasting panels to evaluate products according to their sensorial characteristics-how they are perceived by the senses of sight, smell, taste, touch, and hearing. In this panel, the focus was on the sensory evaluation of different ice cream samples, with sweetness level as the main parameter tested. All the tasting panels were blind.

Starting with the aging process, all five tasters identified non-aged samples (undergoing just rapid cooling over 1-2 h at 4° C.) to be sweeter than aged samples (which underwent the aging part of stage 106, of 16 h at 4° C.). These samples were all of disclosed ice cream products, including the suspension of micronized sugar in oil added after the cooling and aging. While based on past knowledge it could be expected that the binding of free water to the stabilizer and the fibers during the aging process would increase the sweetness of the final product, the results are actually contradictory to common knowledge. Without being bound by theory, it seems that the opposite effect occurs, namely that water is freed from the ice cream matrix during aging, and reduces the sweetness of the final product.

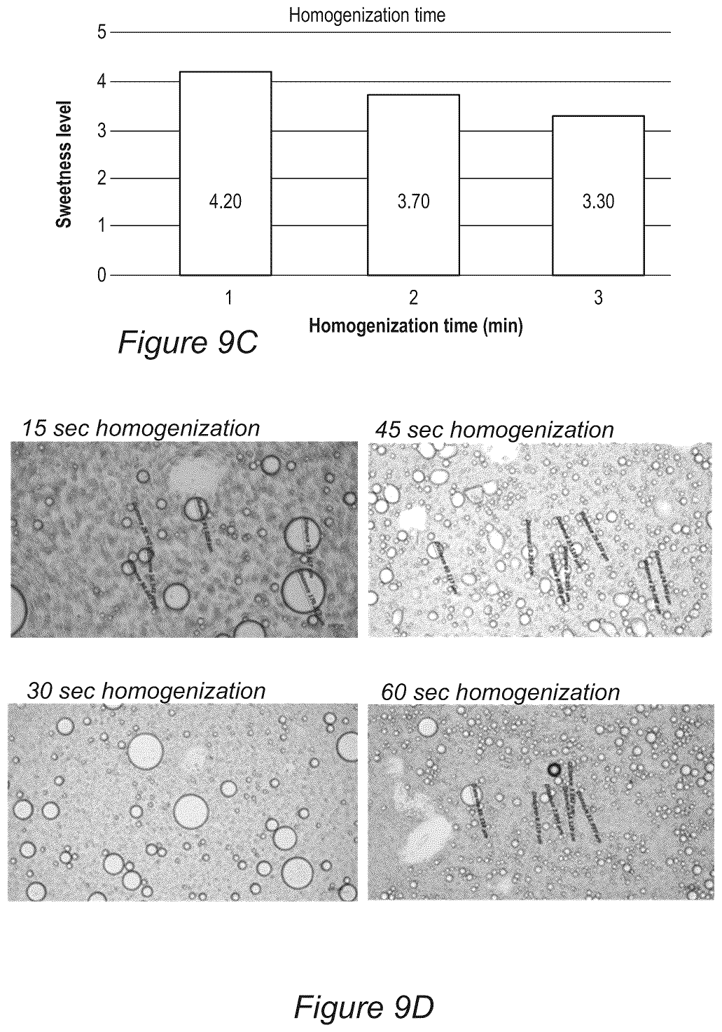

Homogenization 112 speed and time were examined. Without being bound by theory it was expected that higher homogenization speeds reduce the sizes of the fat globules in the suspension of micronized sugar in oil, exposing more microcrystalline sugar to free water in the mix and reducing the sweetness of the product. Testing three homogenization speeds for 1.5 minutes, and after further processing, FIG. 9A illustrates that indeed higher homogenization speeds resulted in lower sweetness. Similarly, longer durations of the homogenization stage were also expected to reduce the sizes of the fat globules in the suspension of micronized sugar in oil, exposing more microcrystalline sugar to free water in the mix and reducing the sweetness of the product. Homogenization durations of one, two and three minutes (prior to further processing) were compared, resulting in the expected decrease in sweetness, as indicated by the results presented in FIG. 9C.

FIG. 9D provides microscope images of ice cream mixes after addition of the suspension of micronized sugar in oil, following different mixing time-indicating one minute as the minimal duration for homogenization. The microscope images visually document the changes in emulsion characteristics during homogenization. Shorter duration of homogenization (15, 30 and 45 seconds shown) result on poor homogenization results and unstable ice cream emulsion, as well as fat separation after further freezing 114. The microscope images indicate that there were too many large globules remaining after brief homogenization (<1 min)—leading to immediate phase separation. The globules should be multiple and have an average distribution of less than 25 μm. It is evident that up to 1 minute, there were too many big globules, and only after 45 seconds to 1 minute was the mix homogenized.

Additionally, the effect of cooling stage 106 (prior to aging) was tested, by adding the suspension of micronized sugar in oil to the mix of powders and liquids (after stages 104 and 105, see FIG. 1C)—at high temperature of 30° C. compared with a low temperature with the mixture cooled to 4° C. (prior to completion of the production process). FIG. 9B illustrates the tasting results, indicating no significant effect of the temperature to which the mixture was cooled before addition of the suspension of micronized sugar in oil. Additional comparisons involving the cooling of the mixture to 1° C., 2° C. and 3° C. before mixing in the suspension—also did not show significant differences.

In conclusion, a correlation was established between the homogenization speed and the final sweetness, wherein high-speed homogenization yields a less sweet ice cream compared to a low-speed homogenization that yields the sweetest ice cream among the three samples tasted. The homogenization time affected the sweetness of the final ice cream, wherein a long homogenization time yielded less sweet ice cream compared to a short homogenization time that yielded the sweetest sample out of the three samples tasted. It is noted that these results may be further adjusted when applied on industrial scale, using industrial homogenization methods (equipment and time), after applying similar analytical analysis, and deriving updated correlations between the globules' size and sweetness. As general guidelines, the homogenization speed should be the lowest speed possible still allowing good mixing and homogeneity of the mix. Homogenization time should be the shortest possible, still allowing good homogeneity of the mix.

The following results were found upon initial investigation of the parameters of disclosed ice cream products.

FIGS. 10A and 10B provide experimental results comparing the iciness resistance of disclosed ice cream products according to some embodiments of the invention—to prior art brands. Freeze-thaw cycles applied to the three types of ice cream included three controlled temperature fluctuations from −15° C. (freezer storing temperature) to +7° C. and back to −15° C., and taste panels (initially nine tasters) estimated the degree of iciness and texture (homogeneity and creaminess) in blind tests of the unmarked products, which were weight-averaged (scores weighted by the respective number of testers) and are presented in FIGS. 10A and 10B. It is noted that disclosed ice cream products provide lower and better results (degree of iciness) in FIG. 10A, and higher and better results (texture quality) in FIG. 10B. Table 4 provides a comparison of the nutritional values of disclosed ice cream products and prior art products. Products by Ben & Jerry's™ and by Häagen-Dazs™ were used in the comparison depicted in FIGS. 10A and 10B, while Glidal™ products were used in the comparison depicted in FIGS. 12A and 12B.

TABLE 4
Nutritional values of disclosed and prior art ice creams.

| | | Ben & | | |
|---|---|---|---|---|
| | Disclosed | Jerry's ™ | Häagen-Dazs ™ | Glidal ™ |
| | ice creams | vanilla | vanilla | chocolate |
| Ingredient | (vanilla) | ice cream | ice cream | ice cream |
| Calories | 374.5 | 230.0 | 249.0 | 74.0 |
| Total Fat | 32.7 | 15.0 | 16.9 | 1.0 |
| Saturated Fat | 27.9 | 8.5 | 10.2 | |
| Total | 14.3 | 20.0 | 19.9 | 11.7 |
| Carbohydrate | | | | |
| Total Sugars | 12.3 | 20.0 | 19.6 | 7.5 |
| Dietary Fiber | 8.1 | | | 8.0 |

As is evident from the results presented in FIGS. 10A and 10B, disclosed ice creams exhibit superior resistance to iciness caused by freeze-thaw cycles and maintain their texture better than prior art products.

The following Tables 5A-5C and corresponding figures present the composition of experimental mixtures used to analyze and understand the synergistic effect of micronized sugar particles suspended in oil, MCT oil and dietary fibers (compared to alternative compositions)—leading to reduced iciness of the ice cream product following freeze-thaw cycles. The baseline disclosed ice cream was made from the suspension of 30% w/w micronized sugar particles in MCT oil, and modifications of the ice cream compositions were studied to detect the key contributors to its increase resistance to iciness due to freeze-thaw cycles. The ice cream products listed in Table 5A were used to compare different forms and types of sugar and oil in the ice cream, the ice cream products listed in Table 5B were used to compare the contribution of fibers to the ice cream, and the ice cream products listed in Table 5C were used to compare ice cream products with different amounts of fibers. All combinations were used to prepare vanilla flavored ice cream and the stabilizer was Fabbri's Neutral Five Cream™. The amounts in each column total 100%, with adjusted quantities of other ingredients when the amounts of bulk ingredients were changed.

TABLE 5A
Ice cream products with forms and types of sugar and oil (all with fibers).

| | | | | Coconut oil |
|---|---|---|---|---|
| | | | Coconut oil | and regular |
| | | Regular sugar | instead of | sugar instead |
| | | instead of | MCT oil as | of micronized |
| | Disclosed | micronized sugar | suspending | sugar suspended |
| Ingredient | ice creams | in suspension | oil | in MCT oil |
| Milk (3%) | 28.9% | 28.9% | 28.9% | 28.9% |
| Cream (38%) | 28.9% | 28.9% | 28.9% | 28.9% |
| Suspension of 30% w/w | 29.2% | | | |
| micronized sugar | | | | |
| particles in | | | | |
| MCT oil | | | | |
| Suspension of 30% w/w | | | 29.2% | |
| micronized sugar | | | | |
| particles in | | | | |
| coconut oil | | | | |
| MCT oil | | 20.4% | | |
| Coconut oil | | | | 20.4% |
| Corn fibers | 11.6% | 11.6% | 11.6% | 11.6% |
| SGF 70R | | | | |
| Cane sugar | | 8.8% | | 8.8% |
| Egg Yolks | | | | |
| Milk powder | 0.8% | 0.8% | 0.8% | 0.8% |
| Ice cream stabilizer | 0.6% | 0.6% | 0.6% | 0.6% |

The inventors have found out that replacing the suspension of 30% w/w micronized sugar particles in MCT oil in disclosed ice cream with non-micronized (regular) sugar in MCT, or with micronized sugar in coconut oil or with non-micronized (regular) sugar and coconut oil-demonstrating the synergy of using micronized sugar particles in MCT oil to provide resistance to texture changes under freeze-thaw cycles.

TABLE 5B
Contribution of fibers to the ice cream, compared to egg yolks (custard,
or Creme Anglaise variations) and compensating for reduced oil and sugar.

| | Custard (egg | | Custard with | Low sugar, |
|---|---|---|---|---|
| | yolks instead | No | fibers (addition | Low fat with |
| Ingredient | of fibers) | fibers (1) | of egg yolks) | 15% fibers |
| Milk (3%) | 29.7% | 32.7% | 26.3% | 37.5% |
| Cream (38%) | 29.7% | 32.7% | 26.3% | 37.5% |
| Suspension of | 29.9% | 33.0% | 26.5% | |
| 30% w/w | | | | |
| micronized sugar | | | | |
| particles in | | | | |
| MCT oil | | | | |
| Corn fibers | | | 11.6% | 15.0% |
| SGF 70R | | | | |
| Cane sugar | | | | 8.2% |
| Egg Yolks | 10.7% | | 9.5% | |
| Milk powder | | 0.9% | | 0.7% |
| Ice cream stabilizer | | 0.7% | | 1.0% |

The inventors have found out that replacing or supplementing the fibers in disclosed ice cream with egg yolks and/or using only stabilizer without fibers, and adding excessive fibers as replacement for sugar and oil-demonstrate the synergy of using fibers with the micronized sugar particles in oil to provide resistance to texture changes under freeze-thaw cycles.

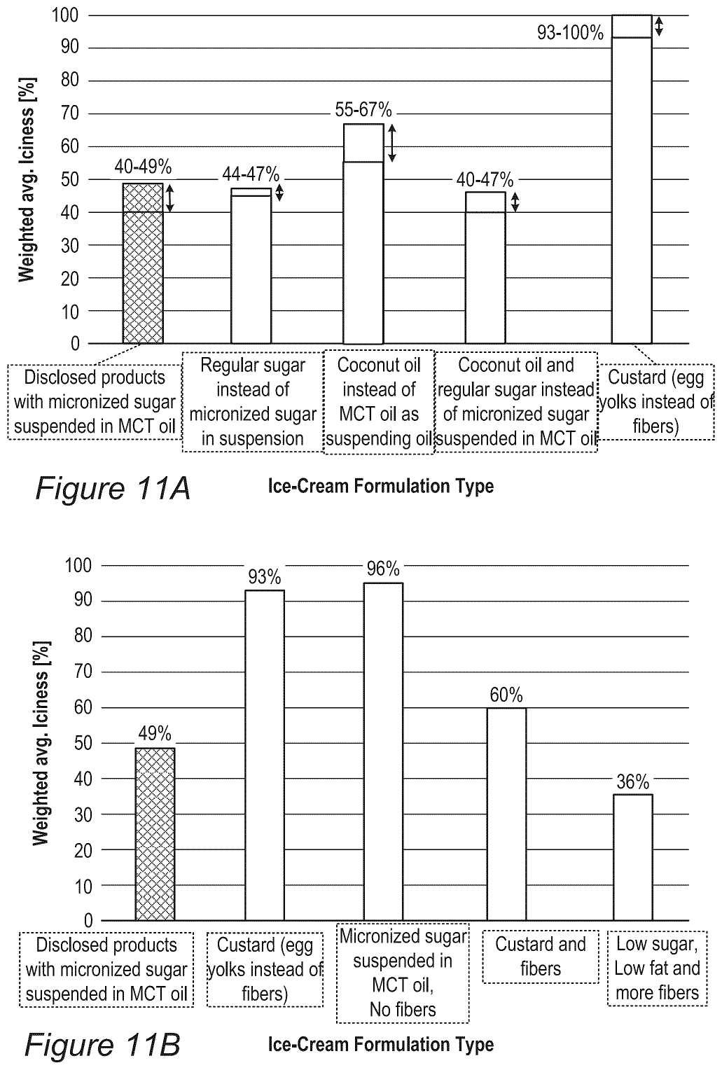

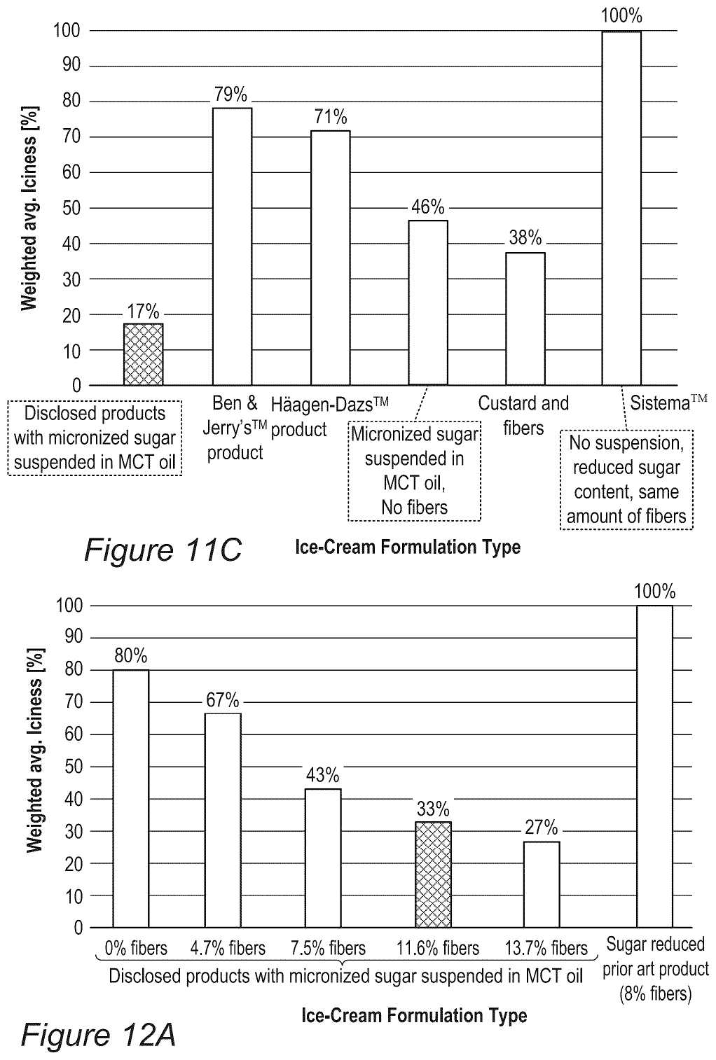

FIGS. 11A-11C provide experimental results from five tasting panels, comparing disclosed ice creams according to some embodiments of the invention—with prior art ice creams and with ice creams prepared with some modification of the ingredients, in order to isolate the contributing factors to the enhanced resistance to iciness of disclosed ice creams. The ranges in the data correspond to the difference between the results of the tasting panels. The compositions of the tested ice creams in FIG. 11A are provided in Tables 5A (regular sugar and coconut oil) and 5B (custard). As illustrated in FIG. 11A, the custard variation (egg yolks instead of fibers) is clearly inferior with respect to iciness and resistance to freeze-thaw cycles, while changing the type of oil to coconut oil and using regular sugar instead of micronized sugar did not have a significant effect. The compositions of the tested ice creams in FIG. 11B are provided in Table 5B (different amounts of dietary fiber). As illustrated in FIG. 11B, ice creams without dietary fibers are inferior with respect to iciness and resistance to freeze-thaw cycles, while including fibers in the custard-base ice cream and increasing the amount of dietary fibers to fill in for reduced fat and sugar content-yield similar resistance as the disclosed ice creams (the former exhibiting somewhat reduced resistance, the latter exhibiting somewhat increased resistance). The compositions of the tested ice creams in FIG. 11C are provided in Tables 5A and 5B (with additional comparison to prior art products), in addition to a commercial product with reduced sugar (recipe recommended by Sistema™)—for another tasting panel including four testers. As illustrated in FIG. 11C, disclosed ice creams products exhibit improved resistance to iciness compared to commercial products and compared to ice creams without fibers or with reduced sugar that is not used in micronized form suspended in oil. The comparison indicates, in addition to the above, that using dietary fibers is not sufficient to increase the resistance to iciness following freeze-thaw cycles, when used in low-sugar ice creams, and that suspension 110 of micronized sugar in oil is an essential component, in addition to dietary fibers, to provide resistance to iciness following freeze-thaw cycles.

It is noted that the various ice cream products tested are similar in nutritional values, the main differences being the amount of dietary fibers and the lower caloric value and fat amount of the low fat low sugar product (ca. ⅔ the calories and only 16% of total fat compared to above 30%).

In conclusion, it seems that synergy between the ingredients is present as no single isolated parameter (micronized sugar, type of oil, the very high amount of fat, amount of dietary fibers) provides the resistance to freeze-thaw cycles, but a combination of these parameters does.

FIGS. 12A-12C provide experimental results from a tasting panel of five people, comparing the effects of different amounts of dietary fibers on the resistance to iciness and on the stickiness of the ice product, according to some embodiments of the invention. FIG. 12A provides the iciness resistance results, FIG. 12B provides the stickiness results, and FIG. 12C illustrates the tradeoff between the iciness resistance and the stickiness by interpolating the results with respect to the amount of dietary fibers. The tested products include disclosed ice creams with 0%, 4.7%, 7.5%, 11.6% and 13.7% dietary fibers with the compositions provided in Table 5C (11.6% corresponds to disclosed ice cream in Table 5A), as well as prior art commercial Glidal™ product with low fat, low sugar, and 8% dietary inulin fibers.

It is noted that disclosed ice cream products provide lower and better results (degree of iciness) than ice creams without fibers in FIGS. 11A, 11B and 12A. The degree of stickiness may be adjusted with respect to requirements related to specific products or markets, e.g., to yield a smooth and creamy mouth feel (more fibers yielding a denser texture, less fibers yielding a thinner, or watery texture). Preliminary tasting tests suggest that a medium level of between 4-8% w/w dietary fiber content may be considered optimal in disclosed ice cream products.

TABLE 5C
Ice cream products with different amounts of fibers.

| | No fibers | 4.7% | 7.5% | 13.7% |
|---|---|---|---|---|
| Ingredient | (2) | fibers | fibers | fibers |
| Milk (3%) | 34.0% | 32.0% | 28.8% | 28.0% |
| Cream (38%) | 34.0% | 32.0% | 28.8% | 28.0% |
| Suspension of | 30.6% | 30.0% | 29.4% | 28.9% |
| 30% w/w | | | | |
| micronized sugar | | | | |
| particles in | | | | |
| MCT oil | | | | |
| Corn fibers | 0.0% | 4.7% | 7.5% | 13.7% |
| SGF 70R | | | | |
| Milk powder | 0.6% | 0.6% | 0.6% | 0.6% |
| Ice cream | 0.8% | 0.8% | 0.8% | 0.8% |
| stabilizer | | | | |

The inventors have found out that a trade-off exists when using fibers in disclosed ice creams made with the micronized sugar particles in MCT oil-between resistance to texture changes under freeze-thaw cycles and stickiness of the ice cream product, which may be used to adjust the specific product characteristics with respect to these parameters.

As illustrated by the results in FIG. 12A, the resistance to iciness caused by freeze-thaw cycles increases in disclosed ice cream products with an increasing amount of dietary fibers.

As illustrated by the results in FIG. 12B, the stickiness of disclosed ice cream products increases with an increasing amount of dietary fibers, and reaches saturation around 11-14%.

Accordingly, the composition of disclosed ice cream products may be adjusted to a required level of iciness resistance and the acceptable level of stickiness, e.g., depending on the type of the ice cream product (e.g., size, typical supply chain, existence of coating, etc.). As illustrated by the results in FIG. 12C, disclosed ice cream products may be optimized to trade off the resistance to iciness and the stickiness depending on the type and characteristics of specific ice cream products. For example, disclosed ice cream products may comprise an amount of dietary fibers around 7%, between 7% and 9.5%, between 4% and 15%, or within sub-ranges at intermediate values thereof.

FIGS. 13A-13D provide microscope images comparing the grain structure after three freeze-thaw cycles of disclosed ice cream products according to some embodiments of the invention (FIGS. 13A and 13B, low level of iciness, ice cream product details in Table 5A) and the grain structure of prior art products (FIGS. 13C and 13D, high level of iciness, Glidal™ low fat low sugar product with 8% inulin fibers), with a common size scale (indicated 100 μm bar). Image optical magnification is ×40. All ice creams were chocolate flavored. These results illustrate visually the textural difference evaluated by the testing panel (see FIG. 11B). Specifically, while ice crystals in disclosed ice creams were small and homogenous (maintaining the texture of disclosed ice cream products and preventing iciness caused by large ice crystals), prior art low sugar high fiber ice cream exhibited non-homogenous growth of ice crystals following thermal fluctuations, corresponding to its poorer texture and iciness.

While ice cream is frozen quickly during production, to yield very small water crystals that contribute significantly to the texture of the ice cream product, thawing cycles along the supply chain and at the customer residence frequently cause accretion and growth of ice crystal—damaging the product's texture. A high content of total solids in the ice cream mix should limit the freezing point depression and contribute to the resistance against temperature fluctuation. Therefore, reduced sugar ice cream products are more sensitive to ice crystal growth resulting from thawing cycles.

Disclosed ice cream products provide on average about 45% sugar reduction compared to the other commercial ice creams (e.g., from 20-18% w/w sugar in current products to less than 15% sugar, typically between 5-12% sugar by weight). Yet it demonstrates a remarkable resistance to temperature fluctuations compared to commercial ice creams, as illustrated, e.g., in FIGS. 10A and 10B. While exploring the commercial ice cream ingredients it was found that this resistance is not due to any of the common ingredients like milk, cream, milk powder etc. Therefore, the ingredients that contributed to the increased resistance were the factors that are unique to the disclosed ice cream products, such as use of micronized sugar crystals suspended in oil-providing a unique sweetening agent, and phase in which it is used, the MCT type of oil, the total amount of fat and the presence of dietary fibers.

MCT oil has a low freezing temperature that is very close to the freezing temperature of water, suggesting that using MCT oil may allow the emulsion to remain stable down to zero degrees, making the MCT oil function as an anti-freezing agent. However, as shown in the experimental results of FIG. 11A, just changing the type of oil to coconut oil which has a higher melting temperature (as an independent ingredient as well as a suspending oil for the micronized sugar)-seems to have a small negative or no effect on the iciness resistance (depending on the sugar component).

As further illustrated in FIG. 11A, just replacing the micronized sugar particles in disclosed ice cream products by crystalline cane sugar (which is then dissolved in the water phase)—seems to have no effect on the iciness resistance. Also, replacing the fibers with egg yolks (custard, or crème anglaise ice creams) while still using the micronized sugar crystals suspended in oil eliminates the resistance to iciness, indicating that the sugar-in-oil suspension alone is not sufficient to provide the resistance to iciness and textural changes caused by freeze-thaw cycles. As illustrated in FIG. 11B, fat content alone is also not sufficient to provide resistance to textural changes caused by freeze-thaw cycles. While fat is considered an important ingredient that affects product hardness, shape retention, and melting resistance after hardening, and while the reduction of fat content in ice cream can thus lead to textural defects such as iciness and coarseness, brittle body and shrinkage, the results in FIG. 11B seem to show that iciness resistance is achievable in low fat ice creams, and that only high fat content (about 30-35% in disclosed ice cream products, in contrast to 1-10% in prior art and low fat ice creams) does not necessarily provide better resistance to iciness.

As illustrated in FIGS. 11B and 12A, the amount of dietary fibers seems to play a significant role in providing resistance to temperature fluctuations, in combination with the use of the suspension of micronized sugar in MCT oil—the more fibers the higher the resistance, possibly with decreasing effects at very high fiber content beyond the tested values. However, the amount of fiber is optimized in disclosed ice creams with respect to the balance between the required resistance to temperature fluctuations and the stickiness conveyed to the product by the fibers—possibly depending on the characteristics of the end product such as type, size, shape, coating, typical supply chain conditions etc. The synergistic effect of the fiber content and the micronized sugar in MCT oil suspension is clearly demonstrated by comparison to the low sugar high fibers commercial product, which performed poorly, having low resistance to iciness. These findings were also verified by microscope images showing non-homogenous growth of ice crystals in the prior art low sugar high fibers ice cream, compared to homogenous and small ice crystals in disclosed ice creams, as shown in FIGS. 13A-13D.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. An ice cream product that is resistant against iciness and texture damage due to temperature fluctuations, the ice cream product comprising, by weight:
a mixture of between 4-15 wt % dietary fibers, mixed with milk powder, 25-70 wt % milk and 0-29 wt % cream,
between 1-40 wt % of a sugar-in-oil suspension, comprising microcrystalline sugar particles suspended in oil, wherein a diameter of the microcrystalline sugar particles is reduced by grinding in the suspension to have a median diameter of less than 15 μm,
wherein the sugar-in-oil suspension is added to the mixture after cooling and optionally aging, and is homogenized therewith,
wherein a total fat content of the ice cream product is at least 15 wt %, and
wherein the ice cream product optionally further comprises up to 2 wt % of additives in total, the additives comprising flavors and/or stabilizers.

2. The ice cream product of claim 1, wherein the sugar-in-oil suspension comprises between 10-65 wt % microcrystalline sugar particles.

3. The ice cream product of claim 1, comprising between 10-40 wt % of the sugar-in-oil suspension.

4. The ice cream product of claim 1, wherein the oil comprises at least one of: MCT (medium-chain triglycerides) oil, C10 (capric acid) oil, grape seed oil, refined coconut oil and/or canola oil.

5. The ice cream product of claim 1, comprising between 15-36 wt % total fat.

6. The ice cream product of claim 1, comprising between 20-30 wt % of the sugar-in-oil suspension.

7. The ice cream product of claim 1, having a low sugar content, a high level of sweetness and a natural taste, lacking an after-taste.

8. The ice cream product of claim 1, coated by a coating having a high thawing temperature, to provide thermal protection.

9. The ice cream product of claim 8, wherein the coating comprises cocoa butter and/or sweet butter made with suspended micronized sugar particles.

10. The ice cream product of claim 1, comprising between 1-20% or between 5-12% sugar by weight.

11. The ice cream product of claim 1, wherein the ice cream product is resistant against iciness after heating above −10° C. or above −5° C. and re-cooling to a lower temperature for one or several cycles.

12. The ice cream product of claim 1, wherein the ice cream product is resistant against iciness after one, two, three or more freeze-thaw cycles.

13. A method of preparing an ice cream product that is resistant against iciness and texture damage due to temperature fluctuations, the method comprising:
mixing milk powder, fillers and optionally stabilizer in powder form, with heated milk and cream in liquid form, without including sugar in the powder mixture or oil in the liquid mixture,
pasteurizing and then cooling and optionally aging the mixture,
adding to the aged mixture and gently homogenizing therewithin-a sugar-in-oil suspension, comprising microcrystalline sugar particles suspended in oil, wherein a diameter of the microcrystalline sugar particles is reduced by grinding in the suspension to have a median diameter of less than 15 μm, and
freezing and packaging the ice cream product.

14. The method of claim 13, wherein, with respect to the ice cream product:
the fillers comprise 4-15 wt % dietary fibers,
the liquid mixture comprises 25-70 wt % milk and 0-29 wt % cream,
the sugar-in-oil suspension is added at 1-40 wt %, optionally between 10-40 wt %, with 10-65 wt % microcrystalline sugar particles in the suspension,
a total fat content of the ice cream product is at least 15 wt %, and
the ice cream product optionally further comprises up to 2 wt % of additives in total, the additives comprising flavors and/or stabilizers.

15. The method of claim 13, wherein the oil comprises at least one of: MCT (medium-chain triglycerides) oil, C10 (capric acid) oil, grape seed oil, refined coconut oil and/or canola oil.

16. The method of claim 13, configured to have the ice cream product include at least one of: between 15-36 wt % total fat, between 20-30 wt % of the sugar-in-oil suspension or between 5-12 wt % sugar.

17. The method of claim 13, further comprising coating the ice cream product by a coating having a high thawing temperature, to provide thermal protection, wherein the coating optionally comprises cocoa butter and/or sweet butter made with suspended micronized sugar particles.

18. The method of claim 13, further comprising adjusting the amount of the sugar-in-oil suspension and the amount of the dietary fibers to enhance a resistance of ice cream product to heating and to prevent or reduce ice formation therein.

19. The method of claim 13, wherein the ice cream product is resistant against iciness or texture damage after any temperature fluctuations, optionally being resistant against iciness or after heating above −10° C. or above −5° C. and re-cooling to a lower temperature for one or several cycles.

20. The method of claim 13, wherein the ice cream product is resistant against iciness after one, two, three or more freeze-thaw cycles.
